(19) United States
(12) Patent Application Publication
(10) Pub. No.: US 2026/0289281 A1
(43) Pub. Date: Sep. 24, 2026

(54) CROSS SPLINE NETWORK

(71) Applicant: Wells Fargo Bank, N.A., San Francisco, CA (US)

(72) Inventors: Ye Jin Choi, Columbus, OH (US); Linwei Hu, Charlotte, NC (US); Vijayan N. Nair, Cary, NC (US)

(21) Appl. No.: 19/085,803

(22) Filed: Mar. 20, 2025

(51) Int. Cl. G06N 3/048; G06N 3/0985

(52) U.S. Cl. CPC G06N 3/048; G06N 3/0985

(57) ABSTRACT

A computer system for machine learning-based prediction is disclosed. The system applies a neural network-based spline transformation to input variables to generate transformed features. The transformed features are processed using a cross network comprising one or more cross layers, each configured to model feature interactions by combining prior layer outputs with learned weight parameters and applying a “cross” (multiplication) transformation with the input features. An output prediction is generated based on the transformed features processed by the cross network. The disclosed approach enables improved modeling of feature interactions while leveraging neural network-based transformations, facilitating enhanced interpretability and computational efficiency in machine learning applications.

### BACKGROUND

Machine learning models are widely used to analyze data and generate predictive insights. While some approaches effectively capture complex relationships, they often lack interpretability or require significant computational resources. Other methods offer greater transparency and efficiency but may not fully capture intricate feature interactions. Existing techniques struggle to balance these trade-offs, limiting their effectiveness in certain applications.

### SUMMARY

Embodiments of the disclosure are directed to machine learning-based prediction using a fully neural network-based architecture that applies a neural spline transformation to input variables to generate transformed features. These transformed features are then processed by a cross network comprising one or more cross layers, where each cross layer models feature interactions by combining prior layer outputs with learned weight parameters and applying a “cross” (multiplication) transformation with the input features. The system generates an output prediction based on the transformed features processed by the cross network. The disclosed approach enables the representation of various machine learning architectures entirely within a neural network framework, allowing for efficient, scalable, and globally optimized implementations using neural network libraries.

In some embodiments, the concept may be implemented to process structured or tabular data and can support various machine learning tasks, including classification, regression, and anomaly detection. The spline transformation serves as an activation function within the neural network and can approximate non-linear relationships using a sigmoid basis function. Additionally, the cross network is structured to control the order of feature interactions by adjusting the number of cross layers. This approach provides a flexible and scalable solution, enhancing predictive accuracy while maintaining transparency in model behavior.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example of a computer system for machine learning-based prediction that applies a neural network-based spline transformation to input variables.

FIG. 2 shows an example fully connected neural network, as a potentially implemented by the system of FIG. 1.

FIG. 3 shows an example neuron of the fully connected neural network of FIG. 2.

FIG. 4 shows an indicator function and sigmoid function approximations performed by the computer system of FIG. 1.

FIG. 5 shows an example cross network configured to operate on the computer system of FIG. 1.

FIG. 6 shows an example cross spline network configured to operate on the computer system of FIG. 1.

FIG. 7 shows test mean squared error (MSE) data for a comparison of five algorithms.

FIG. 8 shows a difference between test MSE and train MSE for a comparison of five algorithms.

FIGS. 9a-h show individual conditional expectation (ICE) plots for a comparison of five algorithms.

FIG. 10 shows test area under the curve (AUC) for a comparison of five algorithms.

FIG. 11 shows a difference between test AUC and train AUC for a comparison of five algorithms.

FIG. 12a-f show ICE plots for a comparison of five algorithms for 50K samples and 10K samples.

FIGS. 13a-c show variable importance for top twenty variables for home lending data.

FIGS. 14a-c show 1d partial dependence plots (PDP) for the top three variables for home lending data of FIGS. 13a-c.

FIGS. 15a-f show 2d PDP for the top two interaction pairs for home lending data of FIGS. 13a-c.

FIGS. 16a-c show permutation variable importance for TreeNet, FCNN, and Xgb.

FIGS. 17a-c show 2d PDP for the top two interaction pairs for the bike sharing data of FIGS. 16a-c.

FIGS. 18a-c show 2d PDP for the most important interaction for the bike sharing data of FIGS. 16a-c.

FIG. 19 shows example physical components of the server device of FIG. 1.

### DETAILED DESCRIPTION

This disclosure relates to machine learning-based prediction using a fully neural network-based architecture. The disclosed approach applies a neural spline transformation to input variables, processes the transformed features using a cross network comprising one or more cross layers to model feature interactions, and generates an output prediction based on the processed transformed features.

In machine learning, structured or tabular data often exhibit low-order, bounded-degree feature interactions, making it challenging for traditional fully connected neural networks (FCNNs) to efficiently model such relationships. Standard FCNNs inherently capture all possible interactions, which may introduce unnecessary complexity when handling structured data. To address this, domain-specific architectures have been developed to optimize predictive accuracy and interpretability for tabular data.

The disclosed framework, referred to as a cross spline net (CSN) is a pure neural network-based framework designed to efficiently handle structured data by leveraging neural spline transformations, projection layers, and cross networks. The spline transformation functions as a neural activation, enabling the model to approximate complex, non-linear relationships within a standard neural network framework. The cross network further refines feature interactions by applying learned transformations at each layer. This approach allows CSN to efficiently model interactions without the need for non-neural network-based models.

Embodiments of the present disclosure provide a scalable and flexible machine learning framework that fully integrates within neural network-based architectures. The CSN framework represents machine learning models in a way that leverages the optimization efficiencies of neural network libraries, enabling researchers to focus on high-level model design rather than computational implementation. By structuring feature transformations and interactions entirely within a neural network, CSN facilitates more efficient training, improved predictive accuracy, and enhanced interpretability for structured data applications.

Additionally, the disclosed embodiments facilitate the identification of correlations between input variables and the predicted output, as well as the modeling of two-way interaction effects among input variables. By bridging the gap between traditional machine learning techniques and neural networks, the CSN framework provides a computationally efficient and interpretable approach for processing structured data in a machine learning environment.

Embodiments of the present disclosure are directed to machine learning-based prediction that integrates neural network-based spline transformations with a cross network comprising one or more cross layers. The disclosed embodiment enables efficient and interpretable modeling of structured or tabular data by leveraging neural network-based transformations to generate transformed features and subsequently processing these transformed features using a cross network configured to model explicit feature interactions. By combining spline-based transformations with neural network-based cross layers, the system facilitates enhanced predictive accuracy while controlling model complexity and computational efficiency.

Embodiments of the present disclosure are directed to a machine learning-based prediction concept that integrates neural network-based spline transformations with a cross network comprising one or more cross layers. The concept enables efficient and interpretable modeling of structured or tabular data by leveraging neural network-based transformations to generate transformed features and subsequently processing these transformed features using a cross network configured to model explicit feature interactions. By combining network-based transformations with neural network-based cross layers, the system facilitates enhanced predictive accuracy while controlling model complexity and computational efficiency.

The example embodiments can include one or more processors and non-transitory computer-readable storage media storing instructions that, when executed by the processors, cause the system to apply a neural network-based spline transformation to input variables to generate transformed features. The spline transformation may be implemented to represent at least one of a spline-based statistical model, a tree-based model, an oblique tree model, a MARS model, or a support vector machine (SVM) model with polynomial kernels. By leveraging these transformation techniques, the system can capture non-linear relationships within the input data while maintaining computational efficiency.

In certain embodiments, the transformation can generate transformed features in the form of a polynomial function applied to a spline transformation of the input variables, enabling a structured representation of non-linear relationships. In some implementations, the spline transformation can approximate non-linear relationships using a sigmoid basis function of the form σ(α+βx), where β and α are optimization parameters, thereby allowing flexibility in adjusting the transformation based on the characteristics of the input data.

Following the spline transformation, the system can apply a dimension reduction operation to the transformed features to improve computational efficiency while preserving relevant feature interactions. The dimension reduction operation may be implemented through linear projection, principal component analysis, autoencoders, or other statistical feature selection techniques. By reducing the number of transformed features, the system can approve performance and reduces unnecessary computational complexity without compromising predictive accuracy.

The dimension-reduced transformed features can then be processed using a cross network comprising one or more cross layers. Each cross layer is configured to model feature interactions by combining prior layer outputs with learned weight parameters and applying a “cross” (multiplication) transformation with the input features. In contrast to fully connected neural networks, where all interactions between input features are implicitly modeled, the cross network explicitly captures feature interactions in a structured manner.

To control model complexity and mitigate overfitting, the system can be configured to limit the highest order of feature interactions to a predetermined depth by restricting the number of cross layers. In some embodiments, the cross network generates polynomial interaction terms up to a predefined degree by stacking multiple cross layers, thereby enabling the system to capture higher-order feature interactions that may be significant in certain predictive tasks.

The cross network may include a configurable number of cross layers, wherein the number of layers functions as a hyperparameter that can be tuned based on a validation dataset. In some implementations, the system is configured to iteratively refine feature interactions by applying multiple stages of feature transformation, wherein each stage incorporates prior layer outputs to construct higher-order feature interactions. By progressively refining interactions, the system ensures that the most informative relationships between features are effectively captured while maintaining computational efficiency.

The disclosed embodiments are particularly well suited for processing structured or tabular data, where traditional neural network architectures often struggle to efficiently capture meaningful feature interactions. The output prediction generated by the cross network may be a probability score, a classification label, or a numerical regression value, depending on the nature of the machine learning task. The disclosed system provides a flexible and scalable approach that enhances predictive accuracy while preserving the interpretability and computational efficiency of neural network-based models.

In certain embodiments, additional optimizations and variations may be incorporated, including adaptive tuning of transformation parameters, alternative approaches to dimension reduction, and extensions to the cross network architecture. These and other embodiments are described in further detail in the following sections.

Embodiments of the present disclosure are rooted in computer technology, addressing specific technical challenges associated with machine learning-based prediction, particularly for structured and tabular data. Conventional neural network-based models, such as FCNNs, require extensive computational resources and prolonged training times to capture complex feature interactions, often resulting in inefficiencies when applied to tabular data. Additionally, traditional machine learning models, including decision trees and gradient boosting techniques, may lack the ability to explicitly model high-order feature interactions without excessive feature engineering.

The disclosed embodiments provide a specific technological solution by integrating neural network-based spline transformations with a cross network architecture, which enables explicit feature interaction modeling while maintaining computational efficiency. By applying spline transformations to input data before processing through a cross network comprising one or more cross layers, the disclosed system reduces the need for exhaustive model training and feature engineering while achieving superior predictive accuracy.

The disclosed concept represents a technical improvement over conventional machine learning architectures by requiring fewer computing resources, reducing neural network training time, and producing more accurate results. By leveraging a neural network-based spline transformation, the system effectively increases the expressivity of input features before processing through the cross network, thereby enhancing model performance. Unlike conventional FCNNs that implicitly capture all possible feature interactions, the disclosed system explicitly models interactions in a structured manner using cross layers, which improves interpretability and prevents unnecessary computational overhead.

Additionally, the ability to configure the number of cross layers as a tunable hyperparameter ensures adaptability to different datasets while optimizing resource allocation. These features collectively enhance the efficiency of machine learning-based prediction systems, demonstrating a specific improvement to computer-implemented models by streamlining feature transformation, optimizing computational efficiency, and improving predictive performance.

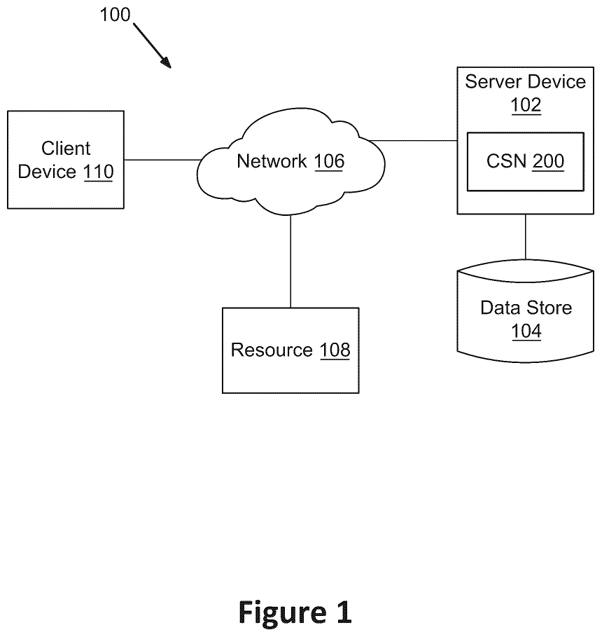

FIG. 1 illustrates an exemplary system architecture of a CSN system 100, which is configured to facilitate machine learning-based prediction by integrating spline transformations with a cross network framework. The CSN system 100 comprises a server device 102, a data store 104, a network 106, one or more resources 108, and one or more client devices 110, collectively forming a networked system for data processing and predictive modeling. The cross spline net CSN200 resides on the server device 102, which is configured to receive data from the data store 104, process the data using machine learning transformations, and communicate with one or more client devices 110 to provide predictive outputs and model insights.

The server device 102 functions as the computational core of the CSN system 100, hosting the CSN 200, which is configured to apply a neural network-based spline transformation to input variables, perform a dimension reduction operation, and process the transformed features using a cross network comprising one or more cross layers. The server device 102 can execute machine learning workflows, store and retrieve models, and facilitate interactions with external data sources and client applications. In certain embodiments, the server device 102 is communicatively coupled to a data store 104, which stores structured or tabular datasets, training and validation data, model parameters, and historical predictions. The data store 104 may also store metadata related to input feature transformations, cross layer configurations, and performance metrics for model evaluation. The server device 102 may retrieve data from the data store 104 for training and inference, enabling continuous model refinement and optimization.

The client device 110 serves as an interface for users to interact with the CSN system 100, facilitating the submission of input data, configuration of model parameters, and retrieval of prediction results. The client device 110 may include a graphical user interface, command-line interface, or an API endpoint that enables integration with external applications. In some embodiments, the client device 110 communicates with the server device 102 via a network 106, which may include the Internet, an intranet, or other communication channels enabling real-time data exchange. The network 106 allows the client device 110 to transmit input features to the server device 102, retrieve prediction results, and access additional computational resources available within the CSN system 100.

The resources 108 of the CSN system 100 may include machine learning algorithms, external data sources, and computational services that support model execution and performance optimization. In certain embodiments, the resources 108 may provide real-time data feeds, cloud-based processing capabilities, or specialized APIs for feature engineering and predictive modeling. The resources 108 may also include third-party data repositories, subscription-based financial indicators, or statistical toolkits that enhance the functionality of the CSN system 100. By leveraging these resources, the disclosed system enables seamless integration of domain-specific knowledge into the machine learning workflow, enhancing model adaptability and predictive accuracy.

In operation, the CSN system 100 applies neural network-based transformations to input data, performs explicit feature interaction modeling through a cross network, and generates predictive outputs that can be utilized for classification, regression, or anomaly detection. By structuring the learning process to incorporate spline-based transformations and cross layers, the disclosed system achieves improved computational efficiency while maintaining interpretability and accuracy in machine learning-based prediction tasks.

A neural network refers to a category of machine learning models, for example deep learning models, which are structured as interconnected layers of nodes (neurons). These models are designed to approximate complex functions and are highly effective for data types like text and images.

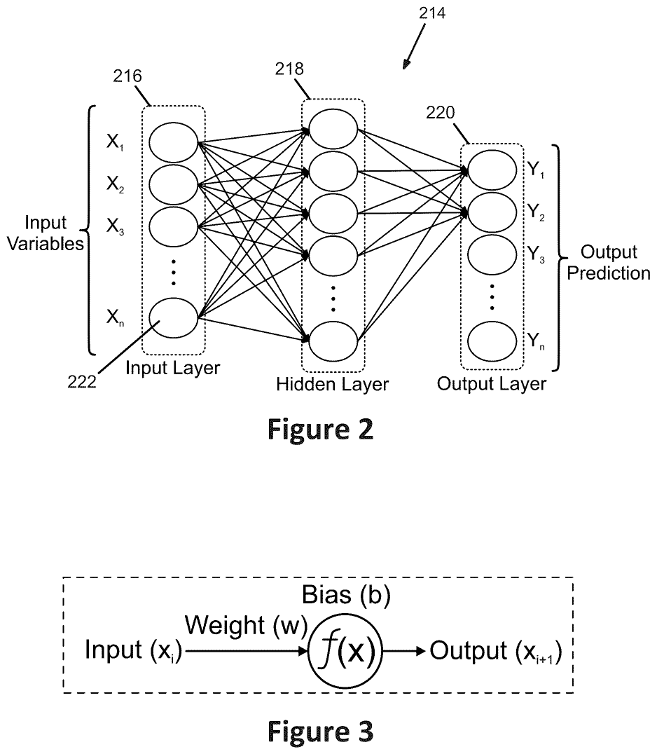

FIG. 2 depicts an example of a deep learning model (or “deep network”) in the form of a fully connected neural network (FCNN) 214.

As depicted, the FCNN 214 can include an input layer 216, one or more hidden layers 218, and an output layer 220. Each of these layers, 216, 218, and 220, can contain a plurality of neurons 222. Although the illustration shows only a single hidden layer 218, it should be noted that multiple hidden layers 218 may be included in the FCNN 214. In some embodiments, the input variables, predictors or causal factors for the input layer can be numerical values falling within a predefined range. In one example, the input layer 216 can incorporate one neuron for each input variable, under evaluation.

As depicted, each of the neurons 222 in one layer, such as the input layer 216, are connected to each of the neurons 222 in a subsequent layer, like the hidden layer 218, through connections 224, establishing a fully connected network architecture. It is also conceivable that the FCNN 214 can be structured as a convolutional network, where one or more groups of neurons 222 within a layer are linked to corresponding neurons in a subsequent layer, each group sharing a weighted value.

With additional reference to FIG. 3, each neuron 222 is configured to receive one or more input values xᵢ and compute an output value xᵢ₊₁. In fully connected networks, each neuron 222 is assigned a bias value b and each connection 224 is assigned a weight value w. These weights and biases are adjustable as the FCNN 214 learns to identify patterns within the data. The function of each neuron 222 is defined mathematically, where the output value xᵢ₊₁ is a function of the weighted sum of input xᵢ and the bias of the neuron. The output xᵢ₊₁ of each neuron 222 can be a numerical value falling within a predefined range. For example, the output of each neuron 222 may be determined by various activation functions, including linear, sigmoid, tanh, and rectified linear unit functions, configured to generally inhibit saturation and stabilize the FCNN 214

The output layer 220 may include neurons 222 corresponding to the required number of outputs for the FCNN 214. For instance, the output layer 220 might feature a single output neuron, with its output value representing the probability of a targeted event occurring (e.g., predicting which home mortgage accounts are likely to be in “trouble”, etc.). Alternate configurations with different numbers of output neurons are also envisaged; for example, output neurons might correspond to the probability of a given home mortgage falling into one or more graded categories according to risk.

The primary objective of the deep learning algorithm is to fine-tune the weights and biases of the FCNN 214 until the inputs at the input layer 216 are accurately mapped to the desired outputs at the output layer 220, thus enabling the FCNN 214 to reliably produce a predicted output for previously unseen inputs. To do this, the weights and biases must be tuned with training data (e.g., data in which a known output is associated with known inputs), thereby enabling the comparison of the predicted output with the known output.

In optimizing the FCNN 214, a cost function, such as a quadratic cost function or cross entropy, is employed to gauge how closely the actual outputs of the output layer 220 match the known outputs from training data. Each complete pass of the FCNN 214 through the training dataset is referred to as one epoch. Over multiple epochs, the weights and biases of the FCNN 214 are progressively adjusted to iteratively minimize the cost function. Effective optimization of the FCNN 214 is achieved by executing a gradient descent on the cost function, aiming to locate a global minimum. A backpropagation algorithm can be utilized to compute the gradient descent of the cost function, calculating the partial derivatives of the cost function with respect to any weight w or bias b in the FCNN 214. This algorithm can facilitate tracking minor adjustments to the weights and biases as they propagate through the network, influence the output, and affect the cost. In some instances, to prevent overfitting, changes to weights and biases can be constrained by a learning rate. Methods of regularization may also be applied to aid in minimizing the cost function.

Traditional FCNNs often struggle to efficiently model structured or tabular data due to their tendency to capture all possible feature interactions, leading to unnecessary complexity. The CSN framework addresses this by structuring all transformations and feature interactions entirely within a pure neural network-based architecture. CSN combines neural spline transformations as activation functions, projection layers, and cross networks, enabling efficient, scalable, and globally optimized learning. By leveraging the capabilities of neural network libraries, CSN eliminates the need for handcrafted algorithmic implementations, allowing researchers to focus solely on high-level neural network architectures.

The spline transformation in CSN is inherently neural network-based, serving as an activation function rather than a separate statistical model. Unlike traditional machine learning techniques such as tree-based models, kernel-based models, or rule-based frameworks, which operate outside the neural network paradigm, CSN ensures that all computations remain within a deep learning framework. This allows for seamless optimization, improved computational efficiency, and enhanced predictive accuracy, particularly in structured data contexts where feature interactions need to be carefully controlled and modeled.

Linear models are statistical models that establish a relationship between a dependent variable and one or more independent variables using a linear equation. Examples include linear regression, which predicts a continuous outcome, and logistic regression, which predicts categorical outcomes. The simplicity and interpretability of linear models make them highly effective when the relationships between variables are approximately linear, such as when modeling straight-line dependencies. Their straightforward nature allows for easy explanation and insight into how predictors influence the outcome.

Spline-based statistical models leverage spline functions, which are piecewise polynomials joined at specific points called knots, to approximate non-linear relationships between variables. Examples include natural splines and B-splines, which provide the flexibility to model non-linear patterns while avoiding overfitting. Spline-based statistical models strike a balance between complexity and interpretability, making them suitable for capturing subtle variations in data that cannot be adequately described by linear models.

Tree-based models use decision tree algorithms to split data into subsets based on feature values, iteratively refining predictions as the tree branches out. Tree-based models include tree ensembles, which combine multiple trees to improve performance and reduce overfitting. Gradient boosting trees, such as XGBoost, build trees sequentially, with each tree correcting the errors of the previous one. Random forests construct multiple trees independently and average their predictions to enhance accuracy and reduce variance.

Oblique trees and forests extend standard decision tree algorithms by splitting data along oblique hyperplanes, which are linear combinations of features, rather than making axis-aligned splits. These algorithms enables oblique trees to capture more complex decision boundaries, making them useful in situations where the relationships between features and the target variable are not easily separated by axis-aligned splits.

Multi-variate adaptive regression splines (MARS) are a flexible regression modeling approach that uses piecewise linear basis functions to describe complex, non-linear relationships between variables. MARS automatically determines the placement of knots (breakpoints) in the data, which allows it to adapt to varying patterns in the dataset. By combining the interpretability of linear models with the ability to model non-linear relationships, MARS provides a versatile tool for regression tasks that demand both flexibility and transparency.

Support vector machines (SVMs) with polynomial kernels are machine learning algorithms that find the optimal hyperplane to separate data into classes or predict outcomes. The polynomial kernel projects data into a higher-dimensional space, enabling the model to learn non-linear decision boundaries, which is particularly effective for non-linear classification or regression tasks, where the flexibility provided by the kernel allows for more accurate separability of data points in complex datasets.

Many spline transformations can be expressed using a common mathematical structure:

$$f ( x ) = Polynominal ( Φ ( x ) )$$

where φ(x) is a polynomial spline transformation function.

The formula for a regression tree can be expressed as:

$$f ( x ) = {\sum }_{i} {a}_{i} ( {\prod }_{j ∈ Path ( i )} I ( {x}_{j} ≷ {c}_{ij} )$$

where αᵢ is the node value for leaf node i in the tree/tree-ensemble, xⱼ is the splitting variable leading to the leaf node, and cᵢⱼ is the split point. Accordingly, φ(x)={I (xⱼ [symbol] cᵢⱼ)}. This formula similarly applies to tree ensembles.

For oblique tree/forests, each split is on a linear projection of the predictors; accordingly

$$Φ ( x ) = \{ I ( {w}_{ij}^{T} x ≷ {c}_{ij} ) \} .$$

For MARS, φ(x)={(xⱼ−cᵢⱼ)₊,(cᵢⱼ−xⱼ)₊}

For SVM, the spline transformation can be infinity dimensional and is not explicitly calculated; however, for dth degree polynomial kernel, F(x) is a polynomial function of degree d, hence φ(x)=x.

To unify approaches, embodiments of the present disclosure propose implementing the class of models described by these functions within a neural network framework. For instance, the indicator function I(x [symbol] c) can be effectively approximated by a sigmoid activation function, σ(α+βx), where β is a large, fixed value (e.g., 20) and α is chosen appropriately to match the threshold c.

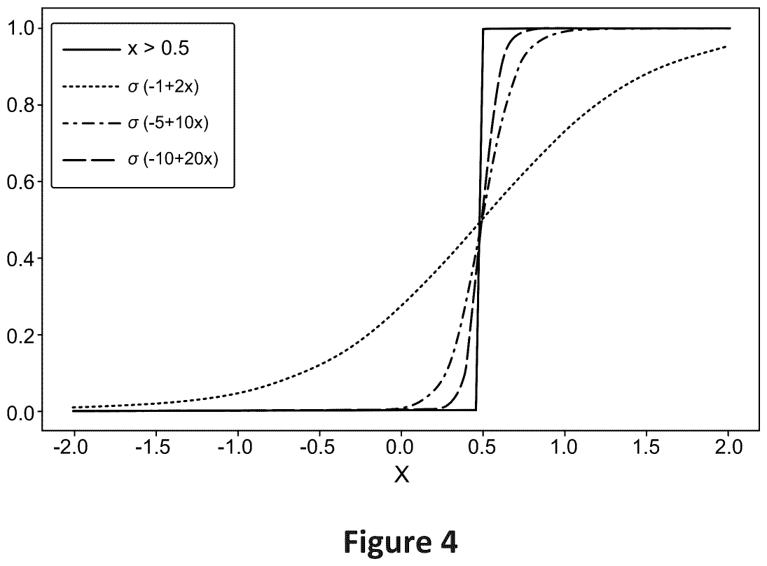

As illustrated in FIG. 4, the indicator function I(x [symbol] 0.5) can be approximated using a sigmoid function. Similarly, the indicator function I(w^{T}x [symbol] c) can be approximated by σ(α+w^{T}x), where w is a weight vector representing the linear combination of input features. Once the indicator function has been approximated, the polynomial function can be implemented within the neural network using the CSN 200 by passing the output of the polynomial function through a cross network.

This approach enables the CSN 200 to handle nonlinearity before the cross network through spline transformation, which is more intuitive from a statistical modeling perspective. Moreover, by operating directly on the original variables, no information is lost during the transformation process, ensuring that the model retains the richness of the input data while bridging the gap between FCNN and spline transformation methodologies.

A cross network 226 is a specialized network comprising one or more cross layers configured to efficiently and explicitly model feature interactions, such as the relationships between two or more input features. Unlike conventional fully connected neural networks, which implicitly capture feature interactions through multiple layers of transformation, the cross network 226 explicitly constructs feature crosses in a structured manner, thereby improving interpretability and computational efficiency.

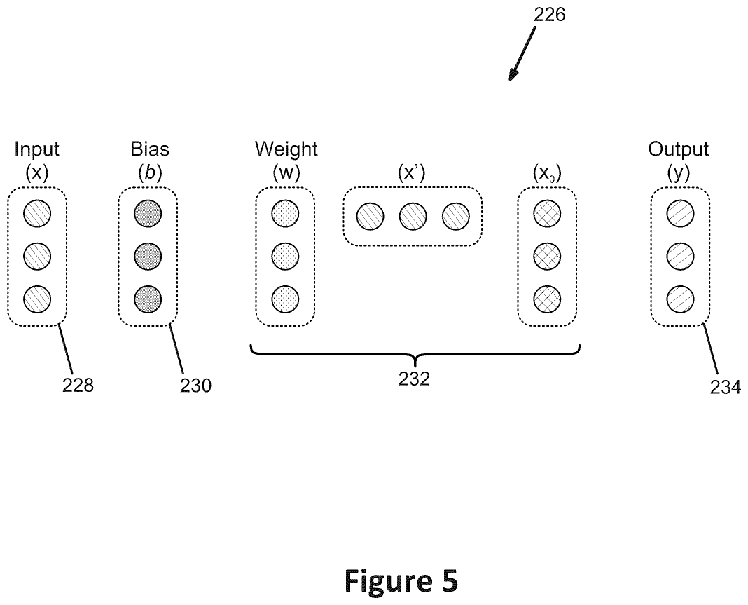

Each cross layer within the cross network 226 is defined by an iterative transformation process, wherein the output of each layer incorporates input features through a feature crossing operation, a learned weight parameter, and a bias adjustment. Mathematically, each cross layer is represented by the following formula:

$${x}_{l + 1} = {x}_{0} {x}_{l}^{T} {w}_{l} + {b}_{l} + {x}_{l} = f ( {x}_{l} , {w}_{l} , {b}_{l} ) + {x}_{l}$$

where xₗ, xₗ₊₁∈ [symbol] are column vectors denoting the outputs from the l-^{th} and l+1-^{th} cross layers, respectively; wₗ, bₗ∈ [symbol] are the weight and bias parameters of the l-th layer. As depicted in FIG. 5, the cross network 226 applies the transformation step-wise, where input 228 (x) undergoes feature crossing with a weight parameter and is subsequently adjusted by a bias 230 (b). This operation generates an interaction term 232 (x₀x′w), which is then added back to the input to produce the final output 234 (y).

Each cross layer refines its feature interactions by combining the input features from previous layers with new transformations, gradually constructing higher-order polynomial interactions. The cross network 226 is structured such that the degree of cross features increases with layer depth. Specifically, for a cross network comprising l layers, the highest polynomial degree (in terms of the original input x₀) is l+1. Consequently, the cross network 226 constructs polynomial cross terms of the form

$${x}_{1}^{α1} {x}_{2}^{α2} … {x}_{d}^{α d} ,$$

spanning all possible interactions from first-order terms to terms of degree l+1, thereby improving model interpretability and reducing computational complexity.

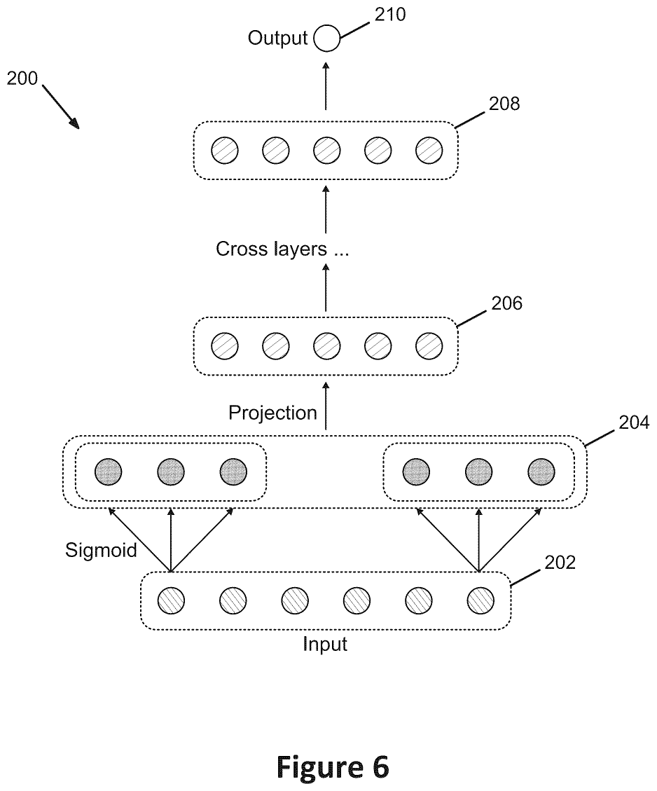

Referring now to FIG. 6, an exemplary (CSN) 200 is depicted in accordance with an embodiment of the present disclosure. The CSN 200 is configured to integrate neural network-based transformations with a cross network architecture, enabling structured feature interaction modeling. In certain embodiments, the CSN 200 is designed to approximate tree-based models and tree ensembles using a sigmoid activation function, facilitating both smooth approximations and discrete threshold-based approximations depending on the characteristics of the input data.

As illustrated in FIG. 6, the CSN 200 can include an input layer 202, a sigmoid activation layer 204, a projection layer 206, one or more cross layers 208, and an output layer 210. The input layer 202 is configured to receive input variables representing structured or tabular data. The sigmoid activation layer 204, positioned immediately after the input layer 202, applies a transformation wherein each input variable xⱼ is mapped to an m-dimensional sigmoid basis, represented as {σ(αᵢⱼ+βᵢⱼ xⱼ), i=1, . . . m, j=1 . . . , p}, resulting in an mp-dimensional basis expansion. Given that not all generated bases contribute significantly to the prediction model, the projection layer 206 is introduced to perform dimensionality reduction, mapping the expanded feature space to a lower-dimensional representation of size d while preserving relevant feature interactions.

Following the projection layer 206, the CSN 200 processes the dimension-reduced features through a sequence of k cross layers 208, each configured to model explicit feature interactions by iteratively applying multiplicative feature transformations combined with additive updates. The number of cross layers 208 (denoted as k) determines the complexity of feature interactions modeled by the CSN 200, wherein the maximum interaction order is represented as k+1. Accordingly, the hyperparameter k operates in a manner analogous to the depth parameter in tree ensemble models, controlling the degree of feature interactions while preventing excessive model complexity.

Finally, the processed feature representations are passed to the output layer 210, which generates a final prediction based on the transformed features. The output layer 210 may be configured to produce a probability score, classification label, or numerical regression value, depending on the specific machine learning task being performed. In contrast to traditional fully connected neural networks, which implicitly model all possible feature interactions without constraint, the CSN 200 explicitly structures feature interactions through the cross layers 208, enabling improved computational efficiency and interpretability.

The CSN 200 is configured to integrate neural network-based architectures with spline transformation-based approaches, thereby combining the advantages of both while mitigating their respective limitations. One such advantage is modularity, wherein the CSN 200 can be efficiently implemented within deep learning frameworks, such as PyTorch and TensorFlow, which provide extensive libraries of pre-built computational modules.

These frameworks enable model construction to be executed in a structured and component-based manner, akin to assembling modular components. For instance, spline transformations can be implemented using pre-existing activation functions, such as ReLU or sigmoid, while linear projections, such as w^{T}x, are inherently embedded in each layer of the network architecture. The cross layers 208 can then be instantiated and stacked to any desired depth, offering flexibility in model configuration while maintaining computational efficiency.

Additionally, the CSN 200 provides access to efficient optimization algorithms that streamline model training and convergence. Deep learning frameworks include a variety of built-in optimization algorithms, such as stochastic gradient descent (SGD), RMSProp, and Adam, which are configured to efficiently navigate complex loss landscapes and identify global optima. These optimizers support mini-batching, facilitating large-scale data processing while enabling efficient utilization of graphics processing units, thereby significantly reducing computational time and resource consumption.

In contrast, traditional spline transformation techniques, such as XGBoost (eXtreme Gradient Boosting), multi-variate adaptive regression splines (MARS), and Oblique Forest models, rely on highly specialized and distinct algorithmic implementations, often requiring different optimization strategies depending on the selected model. Furthermore, tree-based models and MARS utilize greedy forward-selection heuristics, while Oblique Tree/Forest models rely on randomized projections, both of which can struggle to achieve globally optimal solutions. The CSN 200, by contrast, mitigates these inefficiencies by providing a unified, scalable, and optimized framework for model training and execution.

Tree-based models exemplify the limitations of greedy learning algorithms. Decision trees, for example, execute split operations one variable at a time, without jointly optimizing across multiple variables. As a result, the root node of a decision tree is determined solely by main effects, disregarding higher-order interaction effects. This limitation makes it particularly challenging to capture pure interaction effects, wherein the model lacks main effects such that E(f(x)|xⱼ)=0. Similarly, MARS models employ a greedy forward-selection algorithm, and Oblique Tree/Forest models cannot easily optimize projection directions w across multiple variables, often defaulting to random projections.

By contrast, the CSN 200 leverages advanced optimization routines within neural network architectures, thereby improving the ability to identify optimal feature interactions and refine projection directions in an automated and globally optimized manner. This advantage is particularly pronounced in Oblique Tree/Forest models, where the CSN 200 dynamically optimizes projection directions rather than relying on predefined or random projections. The same optimization principles apply to tree-based models and tree ensembles, particularly in cases where pure interaction effects are present.

Another technical advantage of the CSN 200 over tree-based methods is its ability to generate smooth function approximations while mitigating the risk of overfitting. Traditional tree-based models utilize indicator functions as basic functions, which are inherently discontinuous. As a result, tree-based models require multiple split operations to approximate continuous functions, which increases the risk of overfitting. In contrast, the CSN 200 employs continuous basis functions, such as sigmoid functions, which facilitate both linear and non-linear approximations while ensuring smooth function transitions (see FIG. 4). This structural advantage enables the CSN 200 to maintain greater versatility across diverse data distributions while preventing excessive model complexity.

The CSN is a fully neural network-based architecture designed to efficiently model structured/tabular data while leveraging the scalability and optimization capabilities of modern neural network libraries. Traditional FCNNs often struggle with structured data due to their tendency to capture all possible feature interactions, leading to unnecessary complexity. CSN addresses this by combining neural spline transformations as activation functions, projection layers, and cross networks, enabling structured feature transformations within a pure neural network framework. This eliminates the need for external statistical models or handcrafted interaction modeling, allowing researchers to focus on high-level neural network architectures rather than algorithmic implementation. By structuring all transformations within the neural network, CSN enhances predictive accuracy, computational efficiency, and interpretability, making it well-suited for structured data applications.

To demonstrate the advantages of the CSN 200, particularly in comparison to XGBoost and FCNNs, embodiments of the present disclosure include example implementations of the CSN 200, referred to as TreeNet and TreeNet2, to facilitate indirect performance comparisons. The TreeNet and TreeNet2 models incorporate a structured feature transformation pipeline utilizing sigmoid basis functions to approximate local linear segments, with optimized knot placement determined by learned weight parameters a and/p. Due to the nature of sigmoid-based transformations, only a limited number of basis functions is necessary to approximate complex relationships in practical datasets. A default parameter value of m=5 was determined to be sufficient, as empirical evaluation indicates that real-world datasets typically exhibit limited oscillatory behavior and do not require excessive basis expansions.

The dimensional parameter d which represents the number of transformed input features, is configured to scale proportionally to the intrinsic dimensionality of the dataset. Empirical results demonstrate that a default value of d=20 provides robust performance across both simulated and real-world datasets. Additionally, the interaction parameter k which defines the order of feature interactions, is selected to align with common characteristics of tabular datasets. Empirical studies suggest that second-order models k=1 provide an effective fit in many cases; however, to capture up to three-way interactions, a default setting of k=2 may be advantageous, ensuring that higher-order feature dependencies are effectively modeled without excessive computational overhead.

TreeNet2 employs an ADAM optimizer with a default learning rate of 0.02, a batch size corresponding to 1% of the dataset size, and learning rate decay set to 0.995 per epoch. The optimal number of training epochs is determined using an early stopping mechanism, which monitors validation performance to prevent overfitting.

It is recognized that all neural network-based models, including CSN 200, are inherently non-deterministic due to their reliance on gradient-based optimization algorithms. The convergence behavior of gradient descent is influenced by initialization conditions, such that the model may converge to either a global or local optimum, potentially resulting in slight variations in learned parameters. In rare cases, the optimization process may become trapped in a suboptimal local minimum, leading to inferior performance. To mitigate these effects, embodiments of the present disclosure provide mechanisms for hyperparameter tuning and multiple independent training runs using different random seed initializations. Executing the CSN 200 optimization process multiple times enables robust convergence behavior, ensuring that the model identifies a strong global optimum and achieves consistent predictive performance.

To empirically evaluate the performance of TreeNet in comparison to XGBoost and FCNN, simulation studies were conducted across multiple experimental scenarios, including main effects, two-way interactions, and three-way interactions. Each scenario was further subdivided into three functional forms, namely: continuous functions, jump-discontinuous functions (involving indicator-based transitions), and pure interaction models. The results of these studies illustrate the effectiveness of CSN 200 in capturing both smooth and complex feature interactions, while maintaining computational efficiency and generalization capabilities.

For the main-effect-only models, two variations were explored. In the continuous functional form (Main_cont), the response function was defined as:

$$f ( x ) = {x}_{1} + 2 {x}_{2}^{2} + 2 {( 1 + {x}_{3} )}^{1 / 3} + 2 {x}_{4} ( {x}_{4} > 0 ) + sin ( 2 π {x}_{5} ) + {e}^{{x}_{6}}$$

where all main effects were continuous.

In contrast, the jumpy functional form (Main_jump) introduced discontinuities for some variables, defined as:

$$f ( x ) = {x}_{1} + 2 {x}_{2}^{2} + 2 {( 1 + {x}_{3} )}^{1 / 3} + 2 {x}_{4} ( {x}_{4} > 0 ) + I ( {x}_{5} > 0 ) + 2 I ( {x}_{6} > 0.5 )$$

For two-way interaction models, three functional forms were examined. The continuous functional form (2way_cont) was defined as:

$$f ( x ) = {x}_{1} + 2 {x}_{2}^{2} + 2 {( 1 + {x}_{3} )}^{\frac{1}{3}} + 2 {x}_{4} ( {x}_{4} > 0 ) + sin ( 2 π {x}_{5} ) + {e}^{{x}_{6}} + 2 {x}_{1} {x}_{2} + 2 sin ( π ( {x}_{3} {x}_{24} ) ) + 2 \vert {x}_{5} {x}_{6} \vert$$

where all effects, including interactions, were continuous.

The jumpy form (2way_jump) included discontinuous interactions and was defined as:

$$f ( x ) = {x}_{1} + 2 {x}_{2}^{2} + 2 {( 1 + {x}_{3} )}^{1 / 3} + 2 {x}_{4} ( {x}_{4} > 0 ) + I ( {x}_{5} > 0 ) + 2 I ( {x}_{6} > 0.5 ) + 2 ( {x}_{1} > 0 ) ( {x}_{2} > 0 ) + 2 ( {x}_{3} > 0 ) ( {x}_{4} > 0 ) + 2 {x}_{5} ( {x}_{6} > 0 )$$

Lastly, the pure interaction form (2way_pure) focused exclusively on interaction effects:

$$f ( x ) = 2 {x}_{1} {x}_{2} + sin ( π ( {x}_{3} + {x}_{4} ) + {x}_{5} sin ( π ( {x}_{6} )$$

where all interactions were pure with no main effects, as detailed later.

For three-way interaction models, the continuous functional form (3way_cont) extended the previous models with higher-order interactions:

$$f ( x ) = {x}_{1} + 2 {x}_{2}^{2} + 2 {( 1 + {x}_{3} )}^{\frac{1}{3}} + 2 {x}_{4} ( {x}_{4} > 0 ) + sin ( 2 π {x}_{5} ) + {e}^{{x}_{6}} + 2 {x}_{1} {x}_{2} + 2 sin ( π ( {x}_{3} {x}_{24} ) ) + 2 \vert {x}_{5} {x}_{6} \vert + 3 {x}_{1} {e}^{\vert {x}_{2} {x}_{3} \vert} + 3 {x}_{5} sin ( π {x}_{4} + 1.5 {x}_{6} )$$

The jumpy form 3wayjump) included higher-order discontinuous interactions:

$$f ( x ) = {x}_{1} + 2 {x}_{2}^{2} + 2 {( 1 + {x}_{3} )}^{1 / 3} + 2 {x}_{4} ( {x}_{4} > 0 ) + I ( {x}_{5} > 0 ) + 2 I ( {x}_{6} > 0.5 ) + 2 ( {x}_{1} > 0 ) ( {x}_{2} > 0 ) + 2 ( {x}_{3} > 0 ) ( {x}_{4} > 0 ) + 2 {x}_{5} ( {x}_{6} > 0 ) + 3 ( {x}_{1} > 0 ) ( {x}_{2} > 0.5 ) ( {x}_{3} < - 0 \text{.5} ) + 3 ( {x}_{4} > 0 ) ( {x}_{5} < - 0.5 ) ( {x}_{6} < - 0.5 )$$

Finally, the pure interaction form (3way_pure) included only pure higher-order interactions:

$$f ( x ) = 2 {x}_{1} {x}_{2} + sin ( π ( {x}_{3} + {x}_{4} ) + {x}_{5} sin ( π ( {x}_{6} ) + 2 {x}_{1} {x}_{2} {x}_{3} + 2 {x}_{4} sin ( π ( {x}_{5} + {x}_{5} ) )$$

For each scenario, 30 predictors (x₁~x₃₀) were simulated from independent uniform (−1, 1) distributions. Under this distribution, certain interaction terms were designed to exhibit no main effects E(x₁x₂|x₁)=E(x₁x₂|x₂)=0, creating “pure interaction” cases that are challenging for tree-based models. These cases highlight the limitations of tree/tree-ensemble methods in modeling pure interactions.

The response is simulated as γ=f(x)+∈, ∈~N(0,1) for continuous case and

$$P ( y = 1 ) = \frac{{e}^{{β}_{0} + f ( x )}}{1 + {e}^{{β}_{0} + f ( x )}}$$

for binary case, where β₀ is selected such that the classes of 1's and 0's are balanced. A total of 10,000 observations were generated for each combination of functional form and response type, split into 70% training and 30% validation sets. An additional test set of 50,000 observations was used to assess performance. These controlled experiments provided a comprehensive comparison of the strengths and weaknesses of the models under different scenarios.

Five algorithms were fit to the data: TreeNet, XGBoost, FCNN, TreeNet2, and XGBoost3. Table 1 provides details on the hyperparameters for the TreeNet, XGBoost, FCNN models. For TreeNet, the search spaces were selected based on effective default values as previously discussed. The learning rate for TreeNet was set higher compared to FCNN due to its simpler structure, which does not require the very small gradient descent steps necessary for FCNN. A learning rate in the range of 0.01-0.02 was found to work effectively for TreeNet.

For all algorithms, random search was conducted over the hyperparameters listed in Table 1, with 20 trials per algorithm. To prevent overfitting, early stopping with a patience of 50 epochs was implemented for all algorithms. Additionally, L2 regularization with λ=1 was applied to XGBoost. For FCNN and TreeNet, the ADAM optimizer was used with a learning rate decay of 0.995 per epoch.

TABLE 1

| Algorithm | Search Space | Fixed Hyperparameters |
|---|---|---|
| TreeNet | Learning rate: [0.01, 0.02] | Decay = 0.995/epoch |
| | Batch size: [1%, 2%] | ADAM optimizer |
| | Number of cross layers: [0, 1, 2, 3] | Early stopping with |
| | Number of bases: [3, 5, 7] | 50 patience |
| | Dimension of projection layer: [10, 20, 30, 40] | |
| FCNN | Layers: [20, 10, 5], [40, 20, 10], | |
| | [60, 30, 15], [80, 40, 20], [100, 50, 25], | |
| | [120, 60, 30, 15], [100, 50, 25, 12], | |
| | [80, 40, 20, 10], [10, 20, 40, 20, 10], [15, 30, 60, 30, 15] | |
| | Learning rate: | |
| | [0.0001, 0.0005, 0.001, 0.002, 0.004, 0.008, | |
| | 0.01, 0.015, 0.02] | |
| | Batch size: [1%, 2%, 4%] | |
| XGBoost | Max depth: [1, 2, 3, 4, 5, 6, 7] | reg_lambda = 1 |
| | Learning rate: [.01, .02, .03, .04, .05, .06, .07] | (L2 regularization) |
| | Subsample: [.5, .7, 1] | Early stopping with |
| | | 50 patience |

The last two algorithms, TreeNet2 and XGBoost3, were fit using fixed hyperparameters. For TreeNet2, the number of cross layers was set to 2, the number of bases to 5, the dimension of the projection layer to 20, the learning rate to 0.02, and the batch size to 1% of the sample size. The best number of epochs was determined using early stopping. Since TreeNet2 is restricted to modeling up to three-way interactions, XGBoost3 was included as a comparison. In XGBoost3, the maximum tree depth was fixed at 3, the learning rate at 0.05, the subsample ratio at 0.7, and L2 regularization at 1. The best number of trees was also selected using early stopping.

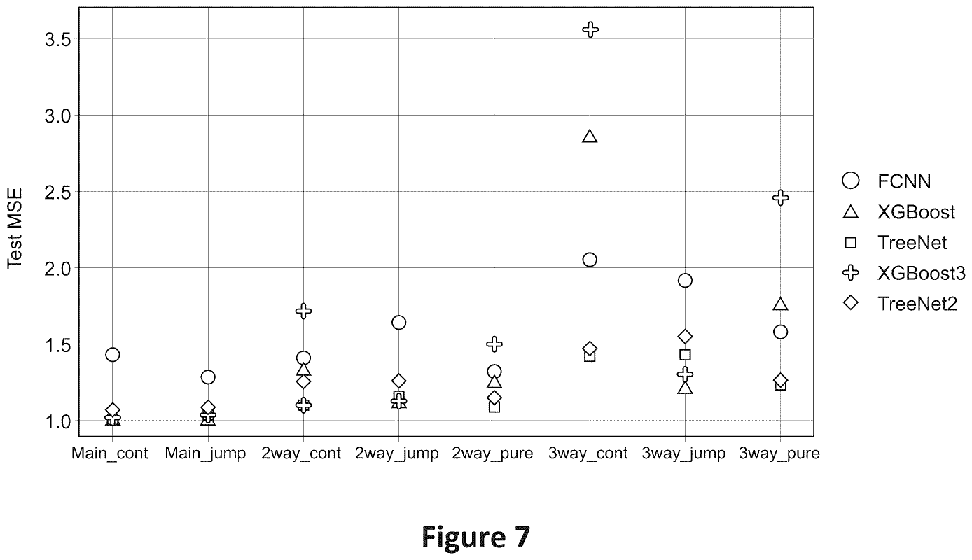

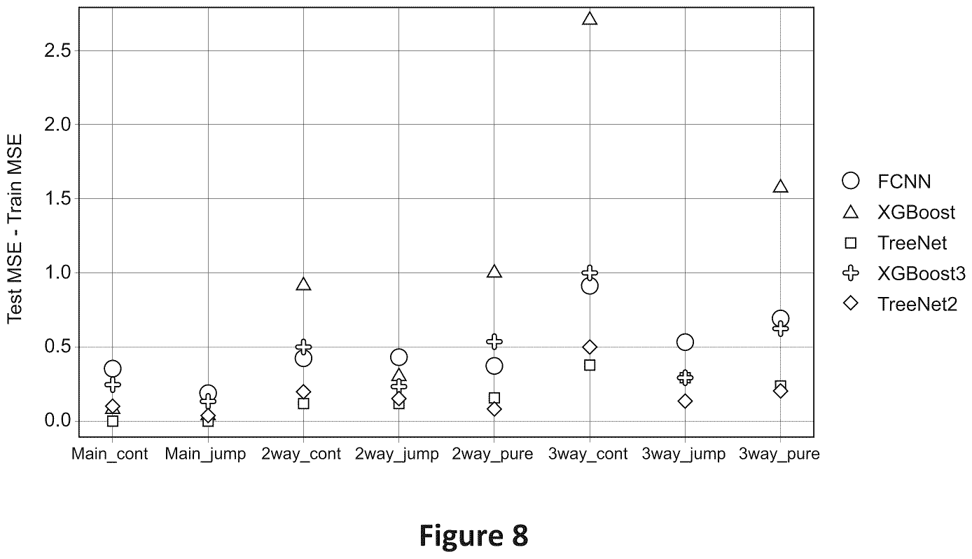

The performance of all five algorithms across the eight cases is summarized in Tables 2a and 2b. The testing mean squared errors (MSEs) are plotted in FIG. 7, while the train-test performance gaps are visualized in FIG. 8.

TABLE 2a

| | Train MSE | | | | |
|---|---|---|---|---|---|
| | TreeNet | FCNN | XGBoost | TreeNet2 | XGBoost3 |
| Main_cont | 0.997 | 1.069 | 0.938 | 0.954 | 0.790 |
| Main_jump | 1.012 | 1.085 | 0.953 | 1.028 | 0.869 |
| 2way_cont | 0.975 | 0.972 | 0.389 | 1.050 | 1.189 |
| 2way_jump | 1.004 | 1.204 | 0.811 | 1.088 | 0.881 |
| 2way_pure | 0.926 | 0.924 | 0.233 | 1.023 | 0.952 |
| 3way_cont | 1.060 | 1.131 | 0.137 | 0.952 | 2.529 |
| 3way_jump | 1.130 | 1.612 | 0.650 | 1.390 | 0.991 |
| 3way_pure | 1.008 | 0.882 | 0.174 | 1.041 | 1.817 |

TABLE 2b

| | Test MSE | | | | |
|---|---|---|---|---|---|
| | TreeNet | FCNN | XGBoost | TreeNet2 | XGBoost3 |
| Main_cont | 1.021 | 1.438 | 1.035 | 1.072 | 1.054 |
| Main_jump | 1.036 | 1.289 | 1.017 | 1.083 | 1.038 |
| 2way_cont | 1.101 | 1.415 | 1.325 | 1.264 | 1.715 |
| 2way_jump | 1.143 | 1.647 | 1.126 | 1.262 | 1.140 |
| 2way_pure | 1.100 | 1.315 | 1.254 | 1.143 | 1.503 |
| 3way_cont | 1.440 | 2.058 | 2.854 | 1.464 | 3.554 |
| 3way_jump | 1.438 | 1.921 | 1.209 | 1.547 | 1.298 |
| 3way_pure | 1.254 | 1.589 | 1.761 | 1.270 | 2.459 |

Focusing on testing performance, TreeNet demonstrates the best performance in all cases except for the jumpy scenarios: main-jump, 2way-jump, and 3way-jump, where XGBoost performs best. This outcome aligns with expectations, as the underlying functions in these cases involve indicator functions, which align well with XGBoost's natural splitting mechanism. However, the difference in test MSE between TreeNet and XGBoost for the main-jump and 2way-jump cases is minimal (~0.02). For the 3way-.jump case, as the number of higher-order jumpy interactions increases, the performance gap becomes more noticeable, with XGBoost achieving a test MSE of 1.209 compared to TreeNet's 1.438 (a difference of 0.23). These results suggest that TreeNet provides a reasonable approximation of jumpy functions and that the performance loss is relatively small when the number of jumpy functions is limited.

Outside of the jumpy cases, TreeNet outperforms XGBoost in all other scenarios. XGBoost performs particularly poorly in the 3way_cont (test MSE: 2.854) and 3way_pure (test MSE: 1.761) cases. One explanation for this is XGBoost's limited suitability for modeling smooth functions. Another reason is XGBoost's difficulty in capturing pure interactions that lack lower-order effects. For a k-order pure interaction, the absence of lower-order effects means the top k-layers of the tree are effectively constructed randomly. A depth-k tree can only capture the interaction signal if one of its leaf nodes happens to split on all k interacting variables.

Since the number of possible combinations for splitting variables is p^{k}, this process becomes exponentially harder as k or p increases. In the 3way_pure case, the XGBoost3 model (with a maximum depth of 3) performs even worse, yielding a test MSE of 2.459 and learning very little from the data. Although the best-tuned XGBoost (with max depth=5) performs better, it remains significantly worse than TreeNet in this scenario.

The performance of FCNN is the weakest overall, except in the 3way_cont and 3way_pure cases, where it outperforms XGBoost but remains inferior to TreeNet. FCNN struggles to capture jumpy patterns and does not perform as well as TreeNet or XGBoost in these cases. Furthermore, FCNN also underperforms in modeling some smooth functions. For instance, in the main_cont case, its test MSE is significantly higher than that of TreeNet or XGBoost.

For TreeNet2 and XGBoost3, TreeNet2 shows strong performance, consistently outperforming FCNN across all cases and coming close to the performance of the fully tuned TreeNet. TreeNet2 performs slightly worse than XGBoost3 in the 2way_jump and 3way_jump cases but is comparable or superior in the remaining scenarios. Notably, TreeNet2 performs particularly well in the 3way_cont and 3way_pure cases, highlighting its ability to effectively model higher-order interactions and smooth patterns.

Turning to the train-test performance gap as depicted in FIGS. 8, TreeNet and TreeNet2 exhibit the smallest gap among the models. This supports the theory that TreeNet overfits less than XGBoost due to its use of continuous basis functions, in contrast to the piecewise nature of XGBoost's splitting mechanism. FCNN, on the other hand, is inherently designed to model high-dimensional interactions, which makes it more prone to overfitting and less suitable for modeling low-dimensional interaction effects. Overall, TreeNet demonstrates comparable or superior performance with less overfitting than the other models.

To further examine the strengths and weaknesses of each algorithm, Individual Conditional Expectation (ICE) plots were used to evaluate the fitted models against the true underlying functions. ICE plots visualize how a model's predictions change for a specific observation when a single variable xⱼ is varied, holding all other variables constant. While partial dependence plots (PDPs) are another common diagnostic tool, ICE plots were preferred in this analysis because PDPs aggregate predictions, making them unsuitable for scenarios with pure interaction effects. For each case, a random sample was selected, and the ICE curves were plotted for each variable. Although the ICE curves vary depending on the sampled observation, consistent patterns were observed across the cases.

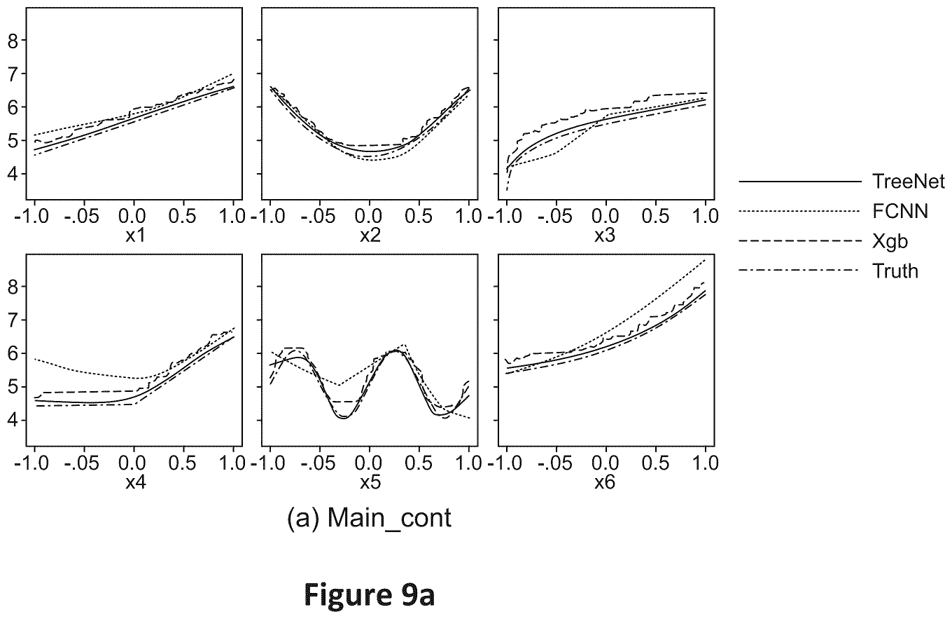

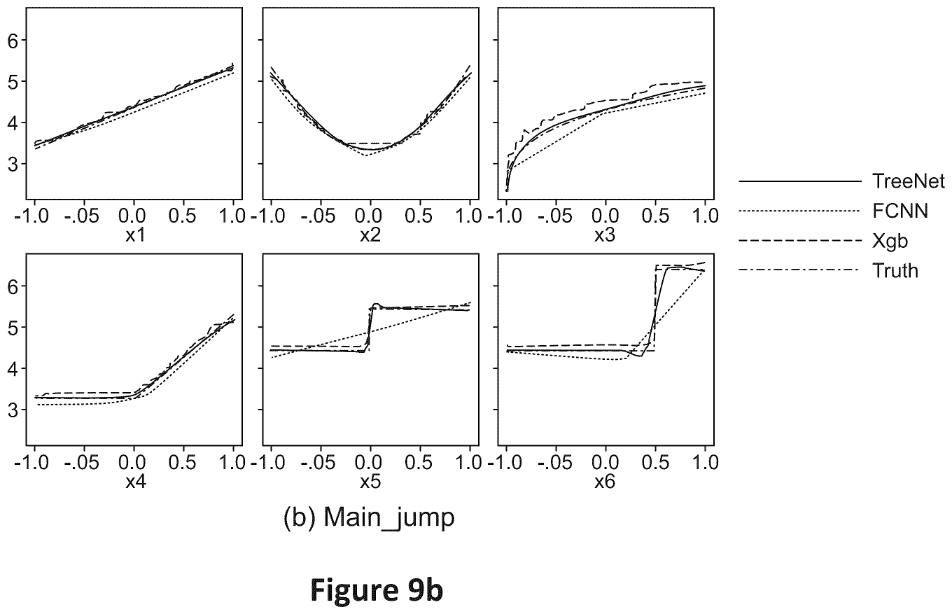

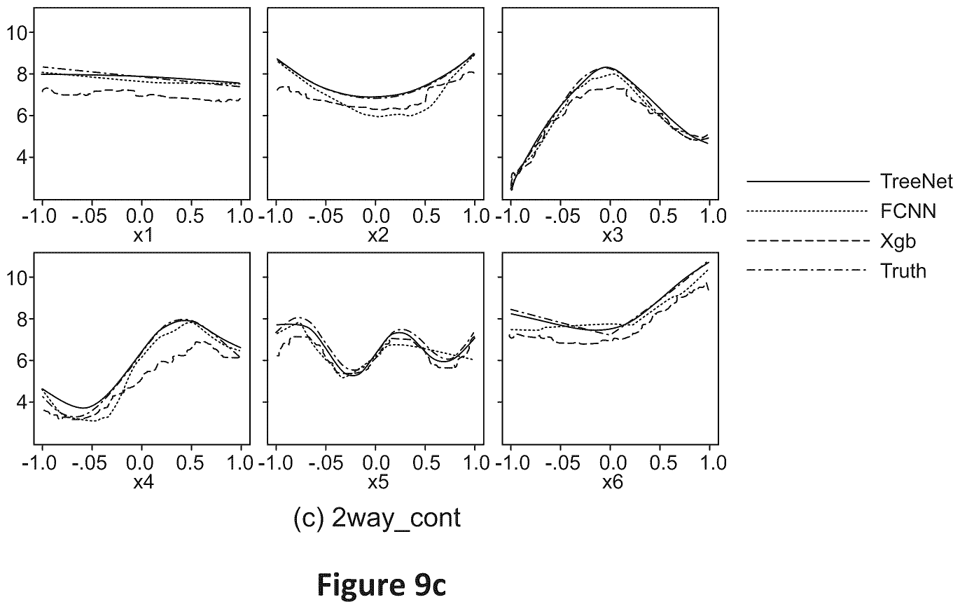

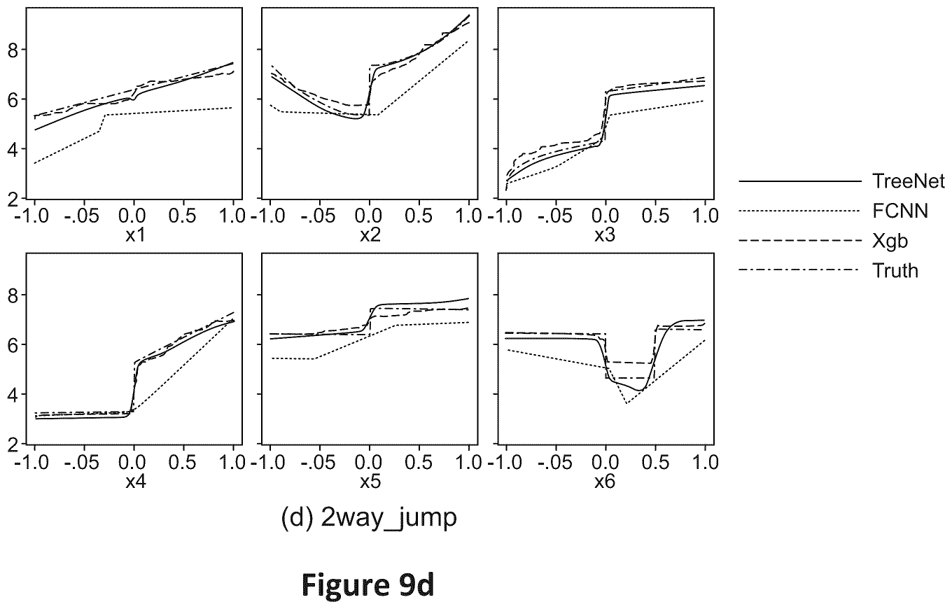

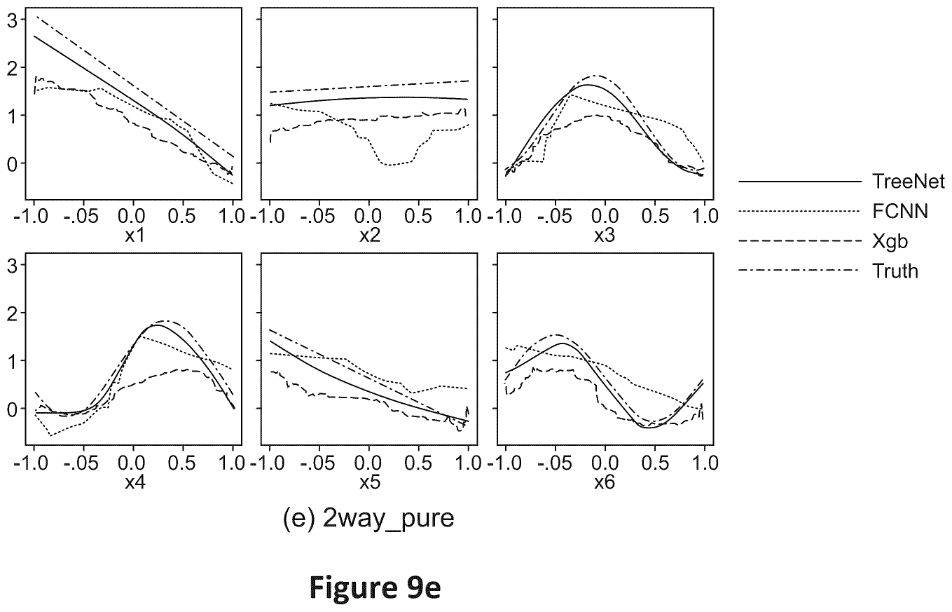

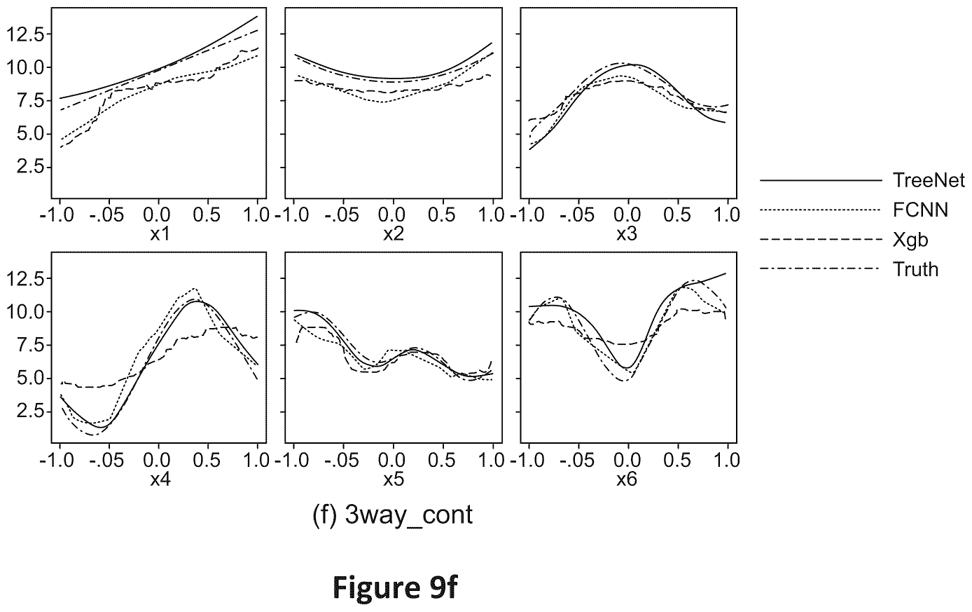

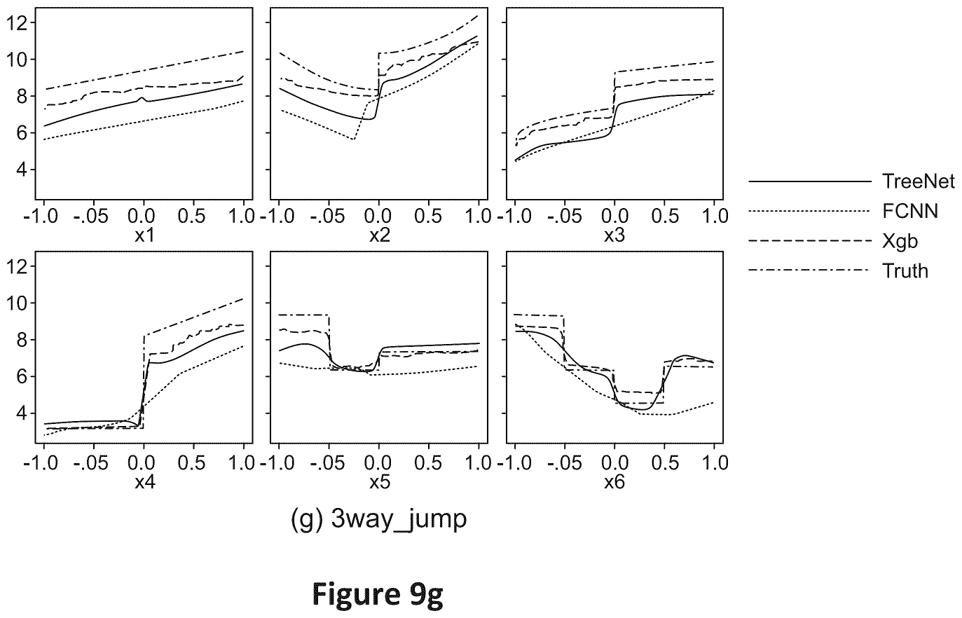

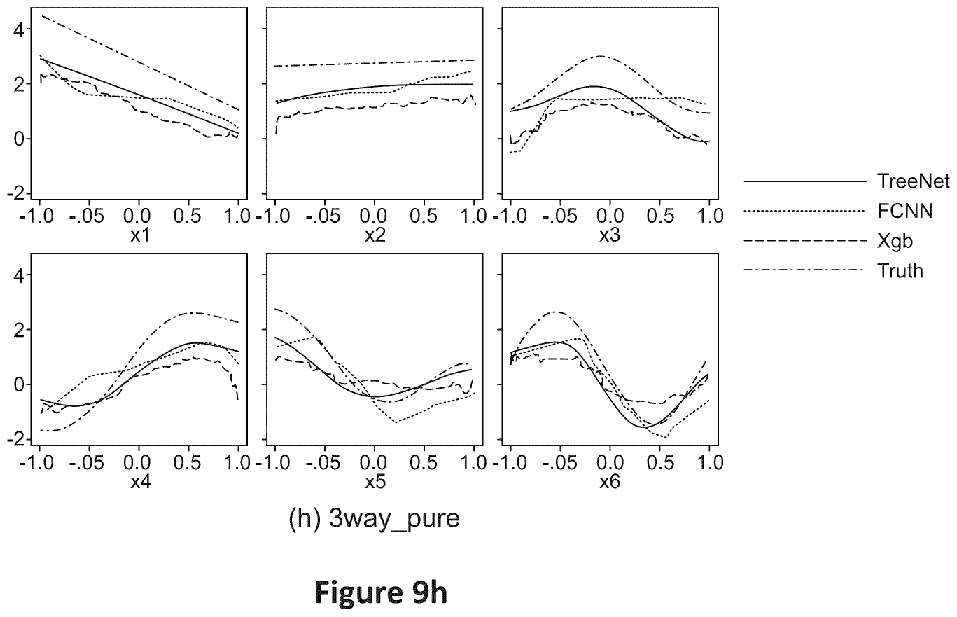

FIGS. 9a-f present the ICE curves for the tuned TreeNet, FCNN, and XGBoost across all eight scenarios. FCNN fails to capture complex patterns, particularly wavy or discontinuous functions. Its use of ReLU activation functions results in continuous, piecewise linear ICE plots, which deviate significantly from the underlying cubic root function (x₃ in main_cont and main_jump), indicator functions (x₅ and x₆ in main_jump, as well as all features in 2way_jump and 3way_jump), and sine functions. FCNN only partially captures the general trends in jumpy functions and the oscillatory behavior of sine functions. As the complexity of the underlying functions increases, FCNN's ability to approximate them diminishes, particularly in cases such as 2way_pure, 3way_jump, and 3way_pure.

XGBoost performs well in approximating the true functions in main_cont and the jumpy scenarios (main_jump, 2way_jump, and 3way_jump), as expected due to its natural splitting mechanism. However, it struggles in other cases, particularly in 3way_cont and 3way_pure. XGBoost produces jagged ICE plots and has difficulty modeling pure interactions and highly nonlinear or oscillatory patterns. For instance, XGBoost fails to accurately capture the true functions involving x₃ and x₄ in 2way_cont, 2way_pure, 3way_cont, and 3way_pure, primarily due to the highly nonlinear term sin(π(x₃+x₄)). Similarly, challenges arise in capturing the sine interactions involving x₆ in 3way_cont x₄ sin(π(x₄+1.5x₆)) and x₅ and x₆ in 3way_pure x₄ sin(π(x₅+x₆)). As the frequency of the sine function increases, the difficulty of accurate approximation by XGBoost becomes even more pronounced.

Across all cases, TreeNet generally provides predictions that align most closely with the true underlying functions, with the exception of 3way_jump, where XGBoost performs better. TreeNet is capable of accurately approximating various types of functions, including the wavy sine functions that pose challenges for both FCNN and XGBoost. Its response surface is smooth, unlike the jagged response surface produced by XGBoost, and it effectively handles jumpy functions when necessary. Even with a training sample size of only 7,000 observations, TreeNet demonstrates its ability to approximate step functions for x₅, x₆ in the main_jump case and for all variables in the 2way_jump case. The accuracy of TreeNet's approximations is expected to improve further with larger training datasets.

TreeNet excels in explicitly modeling low-order interaction effects by utilizing products of splines, where both the splines and their interactions are optimized globally rather than through the greedy, local optimization approach used in XGBoost. As a result, TreeNet consistently performs well across a variety of scenarios, while FCNN and XGBoost show limitations in handling certain types of feature interactions and patterns.

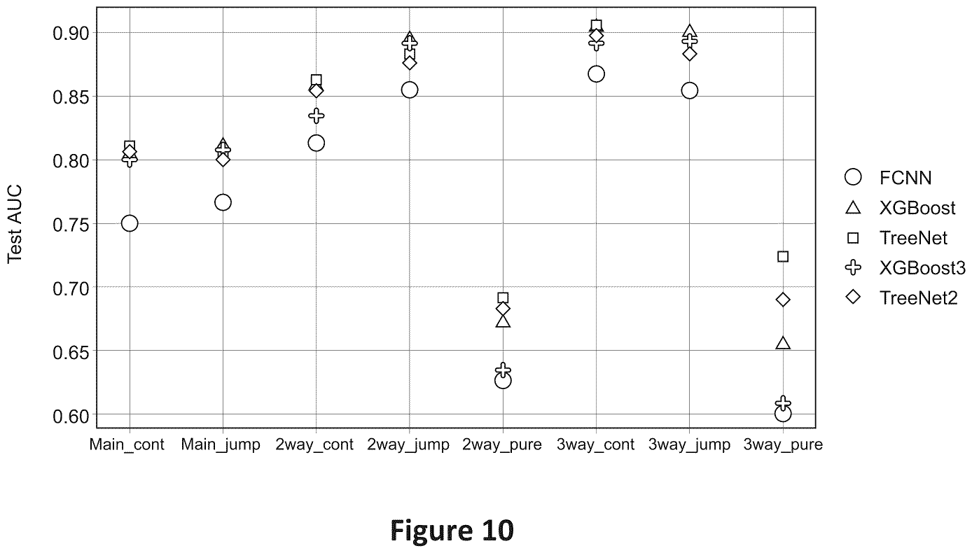

The results for the binary response case are qualitatively similar to those observed for the continuous case. The model performances are presented in Tables 3a and 3b, with test AUCs plotted in FIG. 10. As before, TreeNet achieves the best performance across all scenarios, except for the jump cases. When comparing TreeNet and XGBoost, ignoring small differences in AUC of less than 0.01, TreeNet performs better than XGBoost in the 2way_pure and 3way_pure cases, while XGBoost outperforms TreeNet in the 2way_jump and 3way_jump cases. The largest performance gain is observed in the 3way_pure case, where TreeNet improves the AUC by 0.067 over XGBoost. FCNN consistently delivers the weakest performance across all cases, with significantly worse AUCs in many scenarios. TreeNet2 performs slightly worse than TreeNet, with an AUC difference of less than or equal to 0.008 in most cases, except for the 3way_pure case, where the difference is 0.034. Nevertheless, TreeNet2 outperforms XGBoost3 in all cases except the jump scenarios and consistently outperforms FCNN.

TABLE 3a

| | Train AUC | | | | |
|---|---|---|---|---|---|
| | TreeNet | FCNN | XGBoost | TreeNet2 | XGBoost3 |
| Main_cont | 0.822 | 0.801 | 0.832 | 0.827 | 0.867 |
| Main_jump | 0.824 | 0.826 | 0.832 | 0.821 | 0.856 |
| 2way_cont | 0.900 | 0.866 | 0.991 | 0.901 | 0.898 |
| 2way_jump | 0.906 | 0.892 | 0.917 | 0.902 | 0.916 |
| 2way_pure | 0.813 | 0.714 | 0.982 | 0.762 | 0.689 |
| 3way_cont | 0.928 | 0.914 | 0.999 | 0.914 | 0.916 |
| 3way_jump | 0.904 | 0.908 | 0.930 | 0.914 | 0.918 |
| 3way_pure | 0.786 | 0.775 | 0.983 | 0.774 | 0.699 |

TABLE 3b

| | Test AUC | | | | |
|---|---|---|---|---|---|
| | TreeNet | FCNN | XGBoost | TreeNet2 | XGBoost3 |
| Main_cont | 0.809 | 0.750 | 0.805 | 0.805 | 0.803 |
| Main_jump | 0.805 | 0.766 | 0.809 | 0.803 | 0.806 |
| 2way_cont | 0.861 | 0.812 | 0.857 | 0.854 | 0.835 |
| 2way_jump | 0.879 | 0.854 | 0.893 | 0.877 | 0.891 |
| 2way_pure | 0.690 | 0.627 | 0.673 | 0.682 | 0.630 |
| 3way_cont | 0.904 | 0.866 | 0.900 | 0.897 | 0.892 |
| 3way_jump | 0.883 | 0.854 | 0.898 | 0.883 | 0.895 |
| 3way_pure | 0.723 | 0.601 | 0.656 | 0.689 | 0.609 |

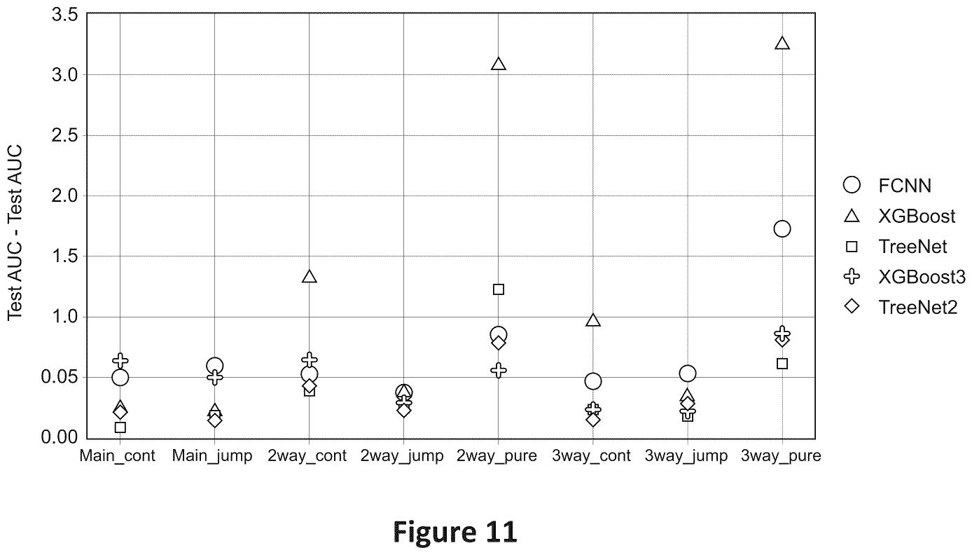

Similar to the continuous response case, the overfitting gap between train AUC and test AUC (as depicted in FIG. 11) is smallest for TreeNet in all cases except 2way_pure. In the 2way_pure case, FCNN and XGBoost3 show smaller gaps, but this is primarily because they fail to learn much from the data, resulting in much lower test AUCs compared to TreeNet. While the tuned XGBoost model achieves a test AUC closer to TreeNet in some cases, the tuned XGBoost model suffers from a large overfitting gap, indicating severe overfitting. This issue is particularly evident in the 3way_pure case, where XGBoost not only delivers a significantly worse AUC than TreeNet but also exhibits a substantial overfitting gap. These results highlight the difficulty XGBoost faces in modeling pure interactions. TreeNet2, like TreeNet, exhibits consistently small overfitting gaps, further demonstrating its robustness.

Accordingly, TreeNet and TreeNet2 offer similar or superior performance to the other models while maintaining smaller overfitting gaps, making these CSN 200 models well-suited for scenarios involving both continuous and binary response variables, particularly in cases with complex interactions or patterns that challenge other modeling approaches.

As the sample size increases, all algorithms exhibit improved performance, with the weakest algorithm, FCNN, showing the most significant improvement. To illustrate this, a simulation study was conducted with a sample size of 50,000 for the 3way cases, covering both binary and continuous responses. The model performance results are presented in Tables 4a and 4b, where the values in parentheses correspond to the results from the 10,000-sample case.

TABLE 4a

| | Train MSE | | | | |
|---|---|---|---|---|---|
| Continuous | TreeNet | FCNN | XGBoost | TreeNet2 | XGBoost3 |
| 3way_cont | 1.017 | 0.994 | 0.497 | 0.985 | 2.321 |
| | (1.060) | (1.131) | (0.137) | (0.952) | (2.529) |
| 3way_jump | 1.077 | 1.056 | 0.833 | 1.027 | 1.070 |
| | (1.130) | (1.612) | (0.650) | (1.390) | (0.991) |
| 3way_pure | 0.994 | 1.018 | 0.388 | 1.019 | 1.418 |
| | (1.008) | (0.882) | (0.174) | (1.041) | (1.817) |
| | Train AUC | | | | |
| Binary | TreeNet | FCNN | XGBoost | TreeNet2 | XGBoost3 |
| 3way_cont | 0.946 | 0.940 | 0.965 | 0.945 | 0.923 |
| | (0.928) | (0.914) | (0.999) | (0.914) | (0.916) |
| 3way_jump | 0.907 | 0.899 | 0.919 | 0.903 | 0.913 |
| | (0.904) | (0.908) | (0.930) | (0.914) | (0.918) |
| 3way_pure | 0.795 | 0.796 | 0.851 | 0.800 | 0.726 |
| | (0.786) | (0.775) | (0.983) | (0.774) | (0.699) |

TABLE 4b

| | Test MSE | | | | |
|---|---|---|---|---|---|
| Continuous | TreeNet | FCNN | XGBoost | TreeNet2 | XGBoost3 |
| 3way_cont | 1.108 | 1.222 | 1.966 | 1.116 | 2.887 |
| | (1.440) | (2.058) | (2.854) | (1.464) | (3.554) |
| 3way_jump | 1.137 | 1.151 | 1.087 | 1.199 | 1.187 |
| | (1.438) | (1.921) | (1.209) | (1.547) | (1.298) |
| 3way_pure | 1.082 | 1.094 | 1.306 | 1.088 | 1.858 |
| | (1.254) | (1.589) | (1.761) | (1.270) | (2.459) |
| | Test AUC | | | | |
| Binary | TreeNet | FCNN | XGBoost | TreeNet2 | XGBoost3 |
| 3way_cont | 0.940 | 0.926 | 0.919 | 0.937 | 0.907 |
| | (0.904) | (0.866) | (0.900) | (0.897) | (0.892) |
| 3way_jump | 0.898 | 0.879 | 0.905 | 0.896 | 0.904 |
| | (0.883) | (0.854) | (0.898) | (0.883) | (0.895) |
| | 0.778 | 0.767 | 0.738 | 0.772 | 0.670 |
| 3way_pure | (0.723) | (0.601) | (0.656) | (0.689) | (0.609) |

TreeNet achieves performance comparable to XGBoost in the 3way_jump case and significantly outperforms XGBoost in the other two cases. FCNN demonstrates the largest improvement, particularly in the continuous response scenarios. For the continuous response, the MSE improves substantially for the non-jump cases, by approximately 0.5-0.8, bringing FCNN's performance closer to TreeNet and surpassing XGBoost in non-jump scenarios. Similar improvements are observed for the binary response case. TreeNet2 performs consistently well across all cases, with only a minor performance difference compared to TreeNet. In contrast, XGBoost3 excels in jump cases but shows significant performance deficits in the other two scenarios compared to TreeNet and TreeNet2.

As the sample size increases, the overfitting gaps diminish for all algorithms. TreeNet maintains the smallest overfitting gap, with the largest MSE gap being less than 0.1 and the largest AUC gap being only 0.017, indicating that TreeNet exhibits almost no overfitting. While FCNN still experiences larger overfitting gaps than TreeNet, its gaps are smaller than those observed for XGBoost. Among all the algorithms, XGBoost demonstrates the largest overfitting gap.

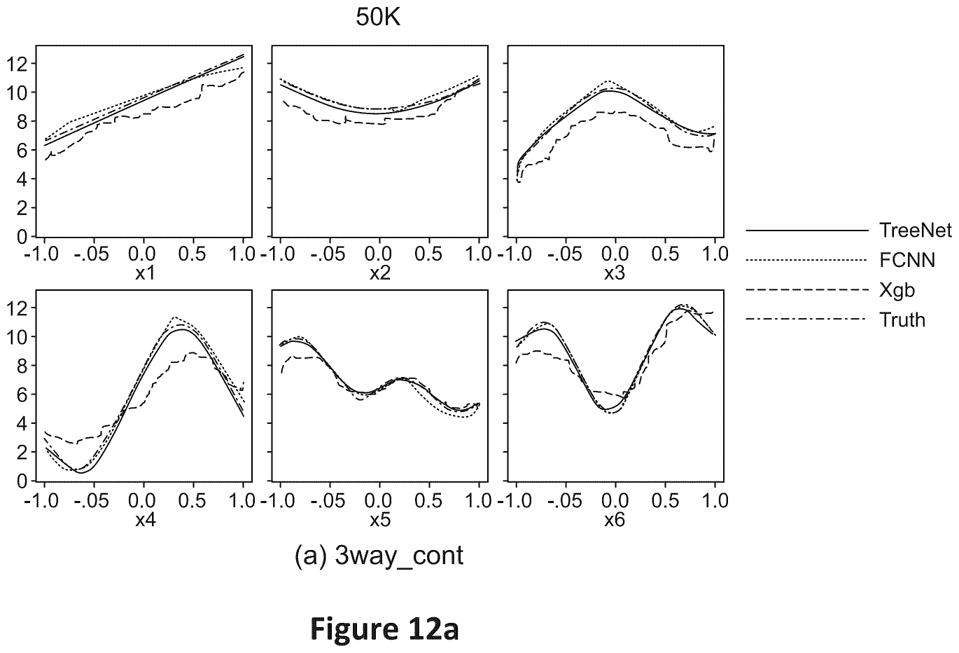

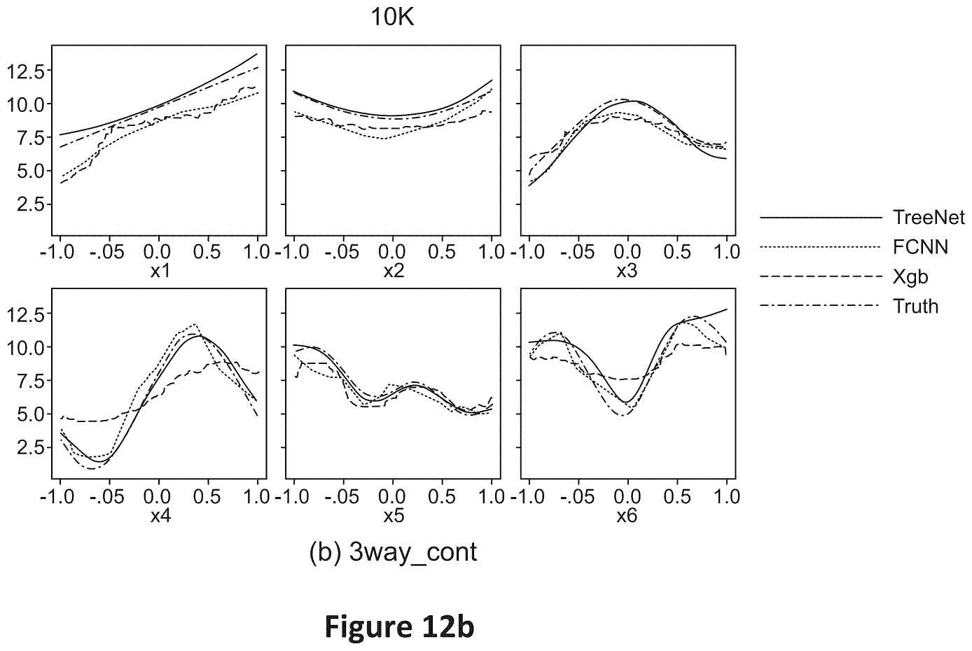

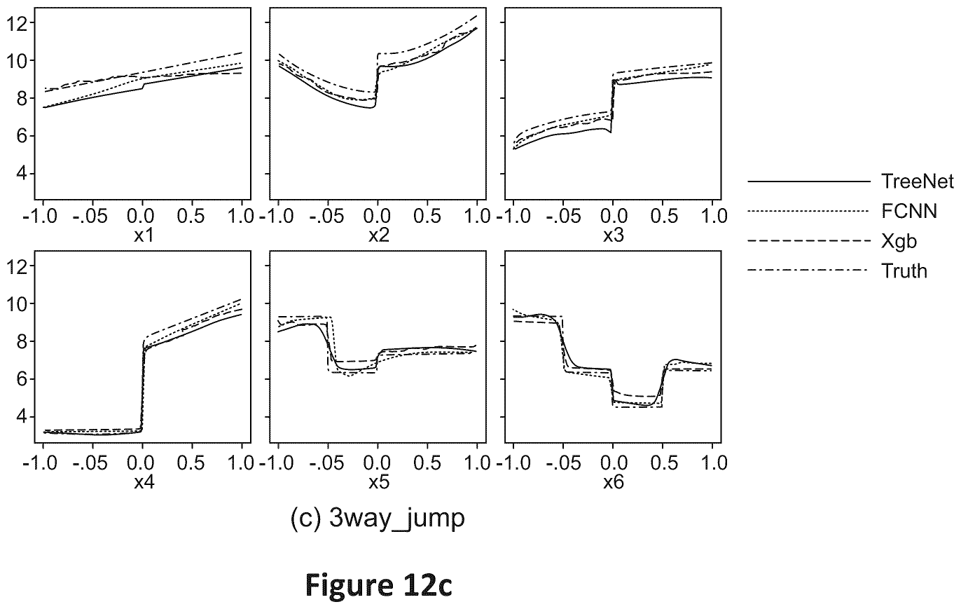

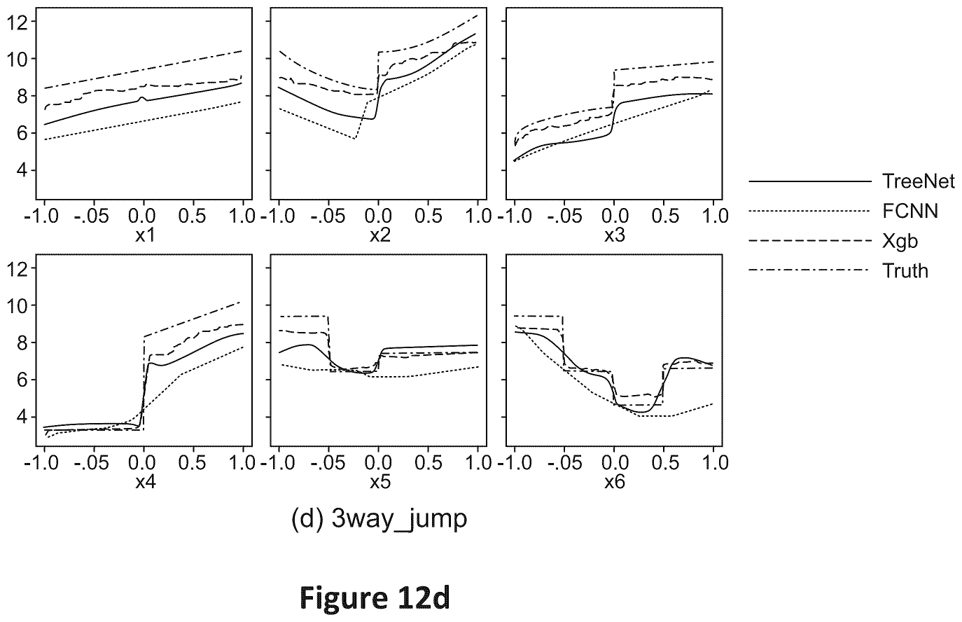

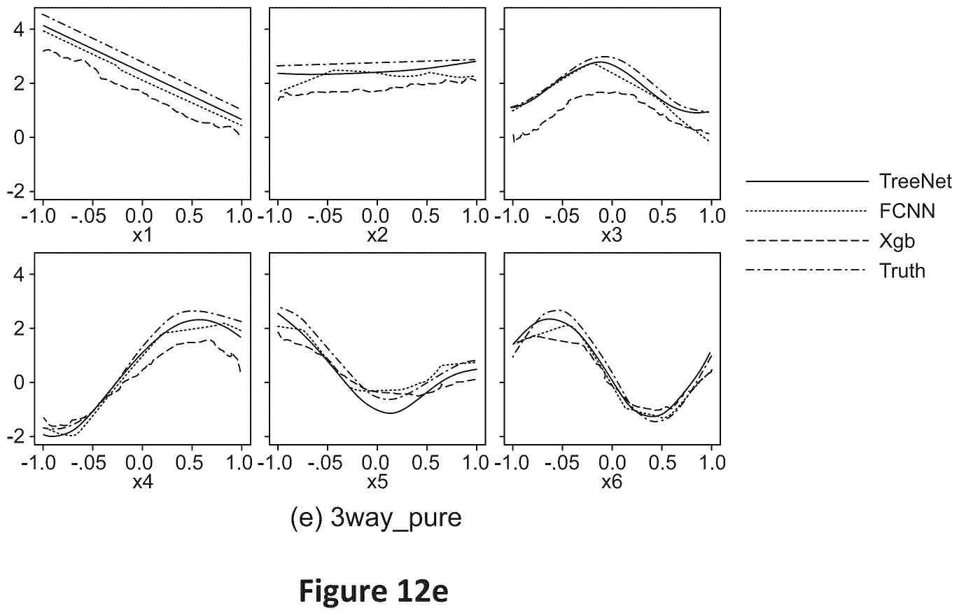

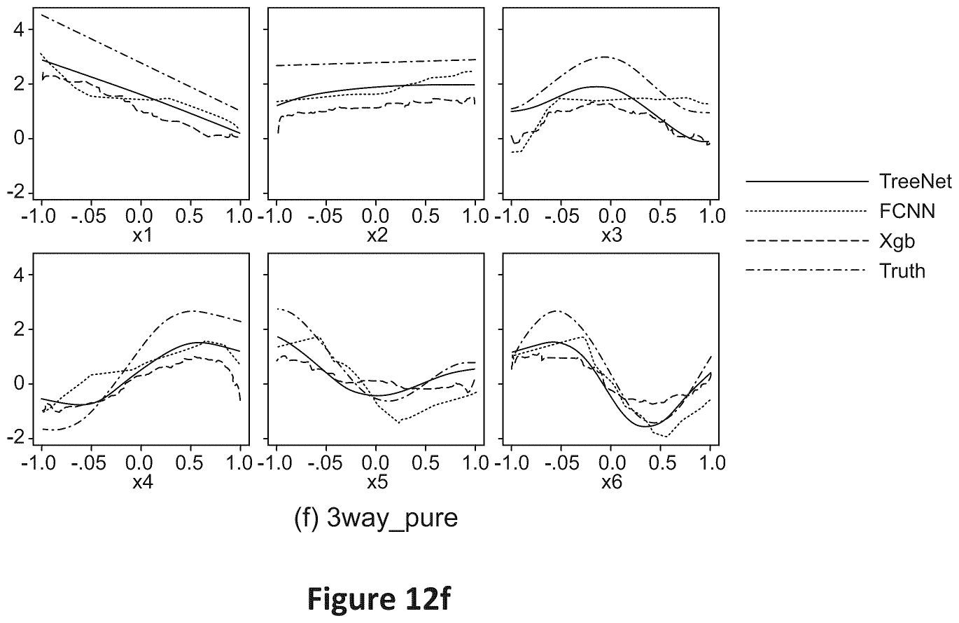

The improved model performance with larger sample sizes is reflected in better alignment of the ICE plots with the true underlying functions. FIG. 12a-f displays the ICE plots for the 3way cases with continuous responses, comparing the results for models trained on the 50,000-sample dataset with those trained on the 10,000-sample dataset (as shown in FIG. 9a-h). Overall, the alignment with the true functions improves across all models, with the most notable improvements observed in FCNN, particularly for the jump functions. TreeNet continues to exhibit the closest alignment with the true functions, outperforming the other models. While FCNN shows substantial improvement, XGBoost still demonstrates a noticeable gap in alignment with the true functions for the non-jump cases, consistent with its relatively weaker performance in these scenarios.

The effectiveness of TreeNet is demonstrated by applying it to two real-world datasets and comparing its performance with XGBoost and FCNN. The first dataset, referred to as the Home Lending dataset, contains residential mortgage account information from a large financial organization. The objective of this dataset is to predict which home mortgage accounts are likely to encounter “trouble” in the future, where trouble is defined as events such as bankruptcy, short sale, or 180 or more days of payment delinquency. This dataset includes over 50 predictors. These predictors encompass macroeconomic variables at the time of prediction, such as unemployment rates and house price indices, static loan characteristics at the time of origination, such as loan types and property types, and dynamic loan characteristics at the current or snapshot time, such as FICO score, delinquency status, and loan-to-value ratio. A summary of key variables is provided in Table 5.

TABLE 5

| Variable | Definition |
|---|---|
| horizon | prediction horizon (difference between |
| | prediction time and snapshot time) in quarters |
| snap_fico | credit score (FICO score) at snapshot time |
| orig_fico | credit score (FICO score) at loan origination |
| snap_ltv | loan to value (ltv) ratio at snapshot time |
| fcast_ltv | loan to value (ltv) ratio forecasted at |
| | prediction time |
| orig_ltv | loan to value ratio at origination |
| orig_cltv | combined ltv at origination |
| snap_early_delq_ind | early delinquency (no min payments for a |
| | few months) indicator: 1 means loan has |
| | early delinquency status at snapshot time; |
| | 0 means loan is current or has late delinquency |
| | status. 7.7% observations are early delinquent. |
| snap_late_delq_ind | late delinquency indicator (loan is delinquent |
| | for longer time, close to default) indicator: |
| | 1 means loan has late delinquency status at |
| | snapshot time; 0 means loan is current or has |
| | early delinquency status. Only 0.2% |
| | observations are late delinquent |
| pred_loan_age | age of loan (in months) at prediction time |
| snap_gross_bal | gross loan balance at snapshot time |
| orig_loan_amt | total loan amount at origination time |
| pred_spread | spread (difference between note rate and |
| | market mortgage rate) at prediction time |
| orig_spread | spread at origination time |
| orig_arm_ind | Indicator: 1 if loan is adjustable-rate |
| | mortgage (ARM); 0 otherwise |
| pred_mod_ind | modification indicator: 1 means prediction |
| | time before 2007Q2 (financial crisis); 0 |
| | if after |
| pred_unemp_rate | unemployment rate at prediction time |
| pred_hpi | house price index (hpi) at prediction time |
| orig_hpi | hpi at origination time |
| pred_home_sales | home sales data at prediction time |
| pred_rgdp | real GDP at prediction time |
| pred_totpersinc_yy | total personal income growth (from year before |
| | prediction to year of prediction time) |

The second dataset, known as the Bike Sharing dataset, is publicly available through the UCI Machine Learning Repository and contains hourly bike rental records from 2011 to 2012 in the Washington, D.C., area. The goal of this dataset is to predict hourly bike rental counts. To stabilize variance typically observed in count data, a log transformation was applied to the rental counts, and the model was trained on the log-count values. The dataset includes 11 predictors that provide information about both time (e.g., hour, day of the week, and month) and weather conditions (e.g., temperature, humidity, and wind speed). The total sample size for this dataset is approximately 17,000 observations.

Both datasets were divided into training, validation, and testing sets, with 50% of the data allocated to training, 25% to validation, and 25% to testing. The training and validation sets were used to tune TreeNet, FCNN, and XGBoost, while the testing set was reserved for assessing model performance. In addition, TreeNet2 and XGBoost3 were also applied, as described in Section 4. The model performance results are summarized in Tables 6a and 6b.

TABLE 6a

| | TreeNet | FCNN | XGBoost | TreeNet2 | XGBoost3 |
|---|---|---|---|---|---|
| Train | 0.865 | 0.865 | 0.907 | 0.867 | 0.888 |
| Test | 0.857 | 0.857 | 0.858 | 0.857 | 0.858 |

TABLE 6b

| | TreeNet | FCNN | XGBoost | TreeNet2 | XGBoost3 |
|---|---|---|---|---|---|
| Train | 0.099 | 0.073 | 0.049 | 0.094 | 0.083 |
| Test | 0.106 | 0.120 | 0.097 | 0.108 | 0.100 |

For the Home Lending dataset, all algorithms produced very similar test AUC values, with a difference of only 0.001 between them. In the Bike Sharing dataset, XGBoost achieved the best performance, slightly outperforming TreeNet, with a test MSE that was 9% smaller. FCNN ranked third in performance, while XGBoost3 performed similarly to XGBoost, and TreeNet2 was close to TreeNet. These results suggest that higher-order effects had minimal impact on this dataset.

In terms of overfitting, XGBoost exhibited the largest overfitting gap, while TreeNet consistently had the smallest gap. This highlights TreeNet's ability to generalize well to unseen data while maintaining strong predictive performance.

The three main algorithms—TreeNet, FCNN, and XGBoost—were further evaluated using model diagnostic tools. A key diagnostic examined was permutation-based variable importance. FIG. 5-1 displays the variable importance rankings for the top 20 variables in the Home Lending dataset. The results reveal a high degree of consistency among the algorithms in identifying the top-ranking variables. XGBoost and TreeNet share 9 out of the top 10 most important variables, while FCNN shares 8 of the top 10 variables with either XGBoost or TreeNet.

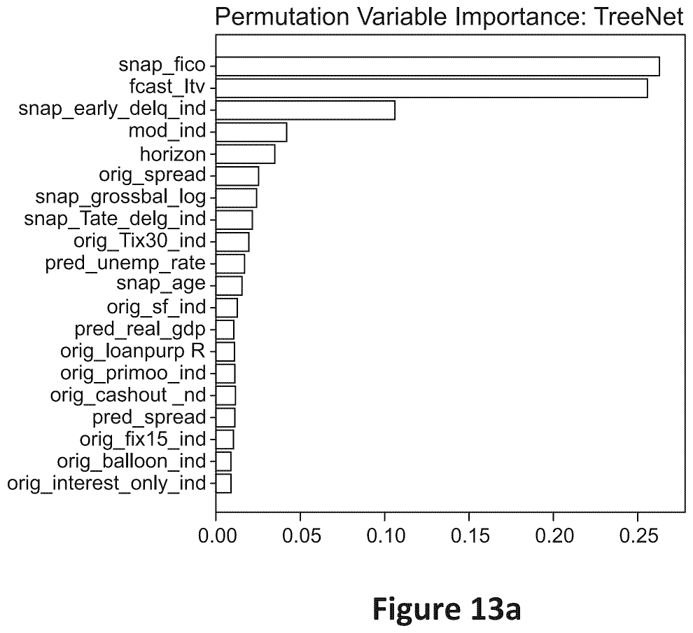

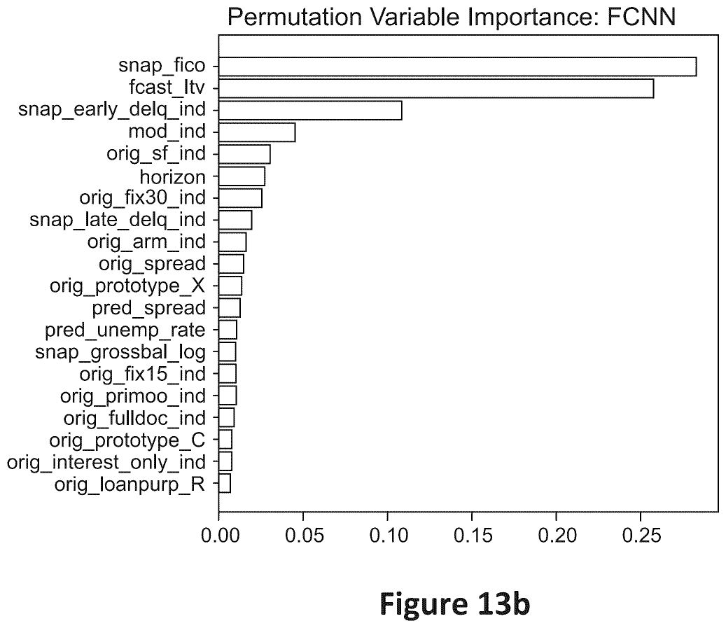

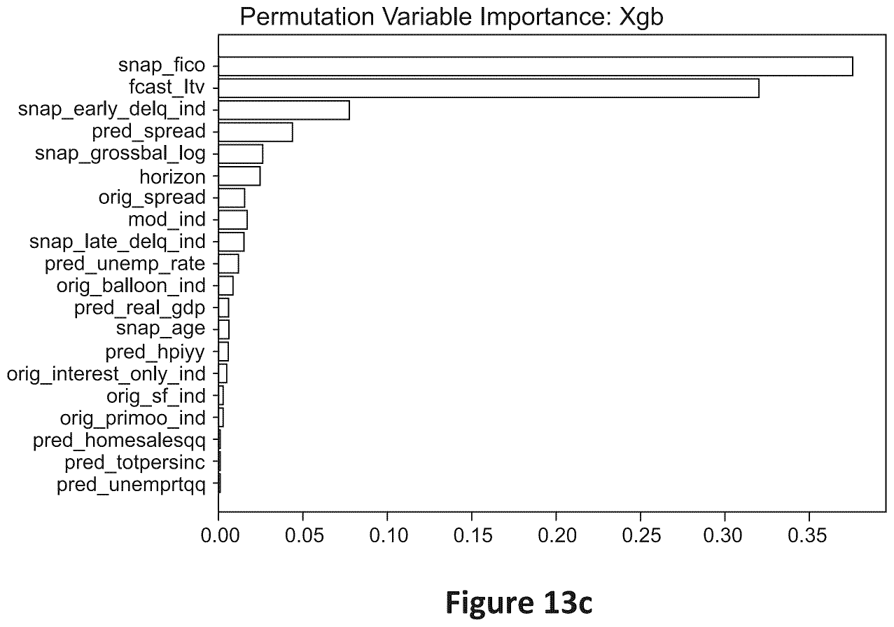

The three main algorithms—TreeNet, FCNN, and XGBoost—were compared using model diagnostic tools, starting with permutation-based variable importance. FIGS. 13a-13c present the variable importance rankings for the top 20 most significant variables in the Home Lending dataset. The results show a high degree of consistency in the top-ranking variables across the algorithms. XGBoost and TreeNet share 9 out of the top 10 most important variables, while FCNN shares 8 of the top 10 variables with either XGBoost or TreeNet.

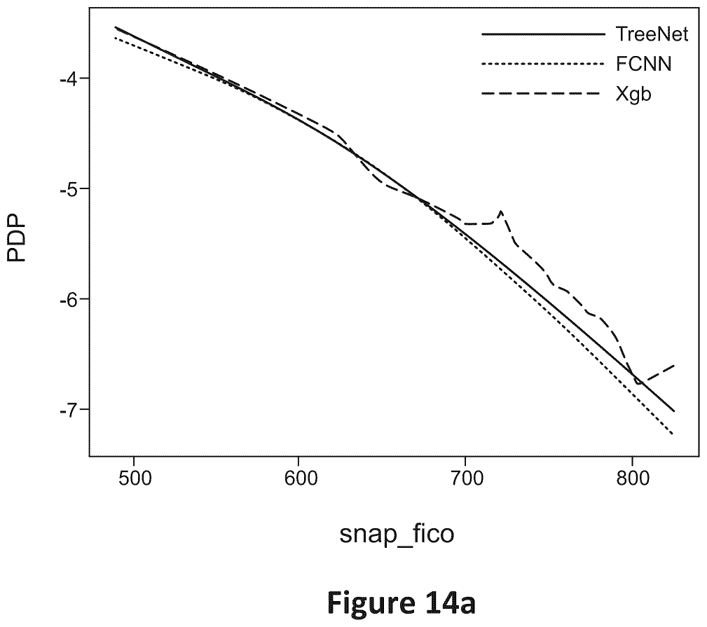

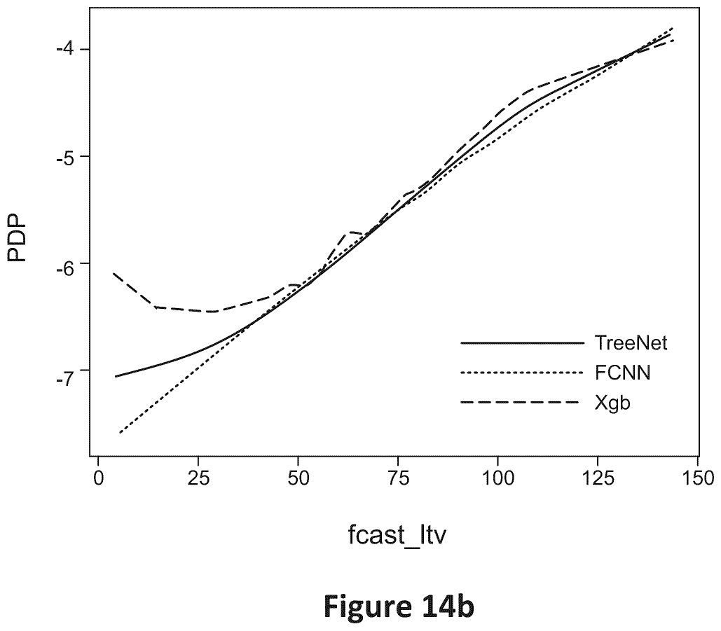

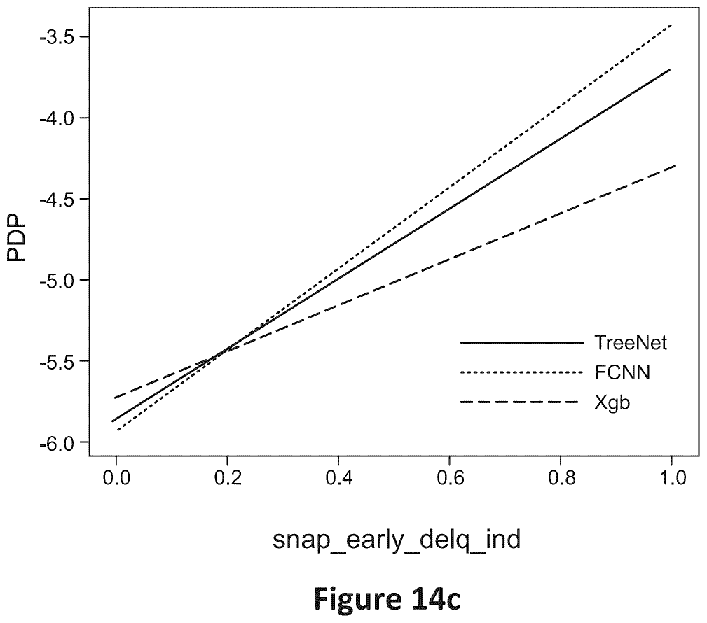

The 1D partial dependence plots (PDPs) for the top three variables are shown in FIGS. 14a-14c. TreeNet and FCNN exhibit very similar patterns, with only minor differences at the tails. Both models produce smooth curves, in contrast to XGBoost, which displays some kinks in the plots. In regions with sparse data, such as the tails or when the early delinquency indicator equals 1, XGBoost shows a slight deviation from TreeNet and FCNN. This discrepancy is expected due to the multiplicity of equally good models that can arise during training.

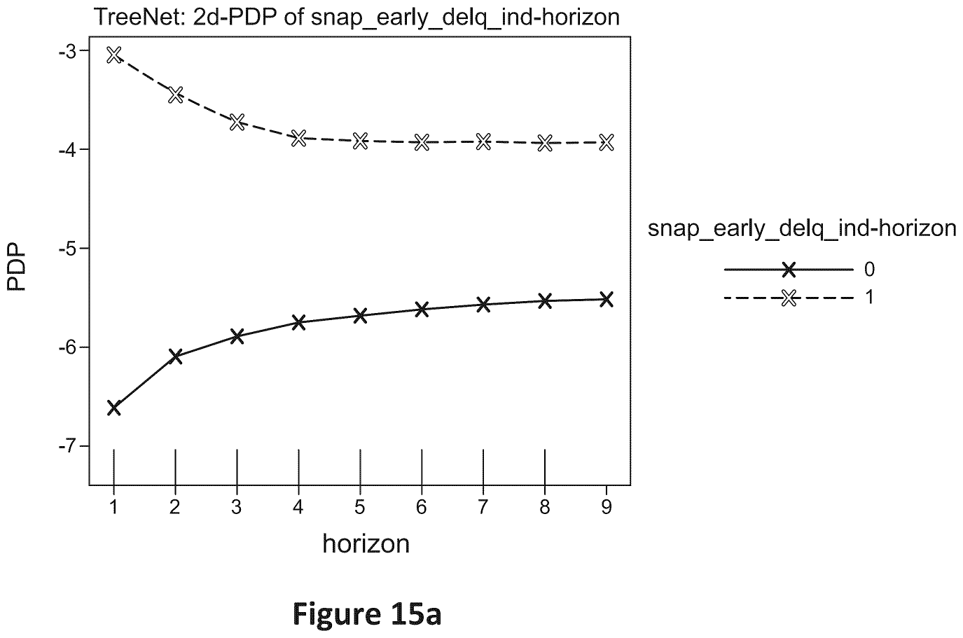

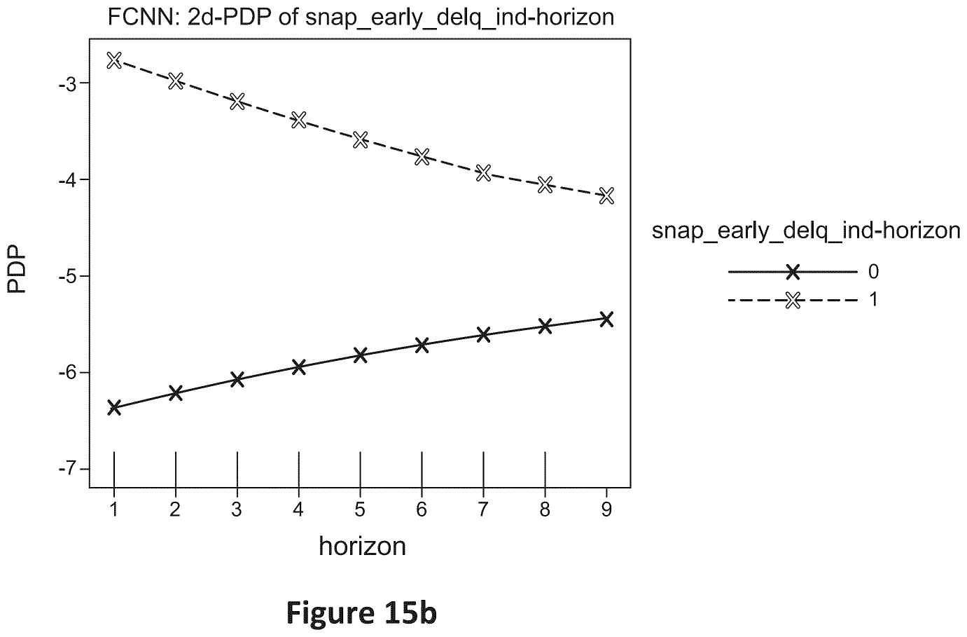

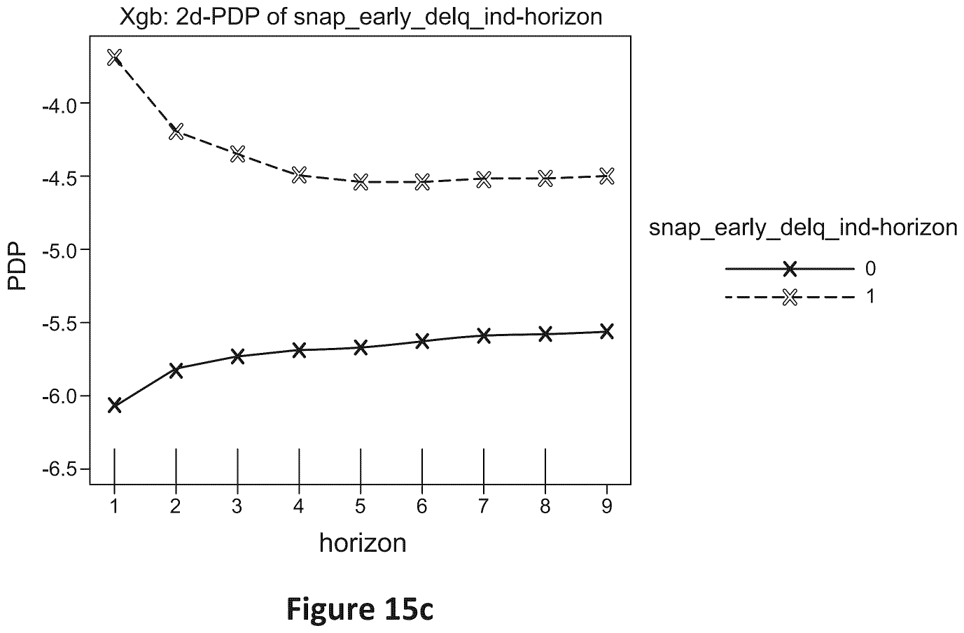

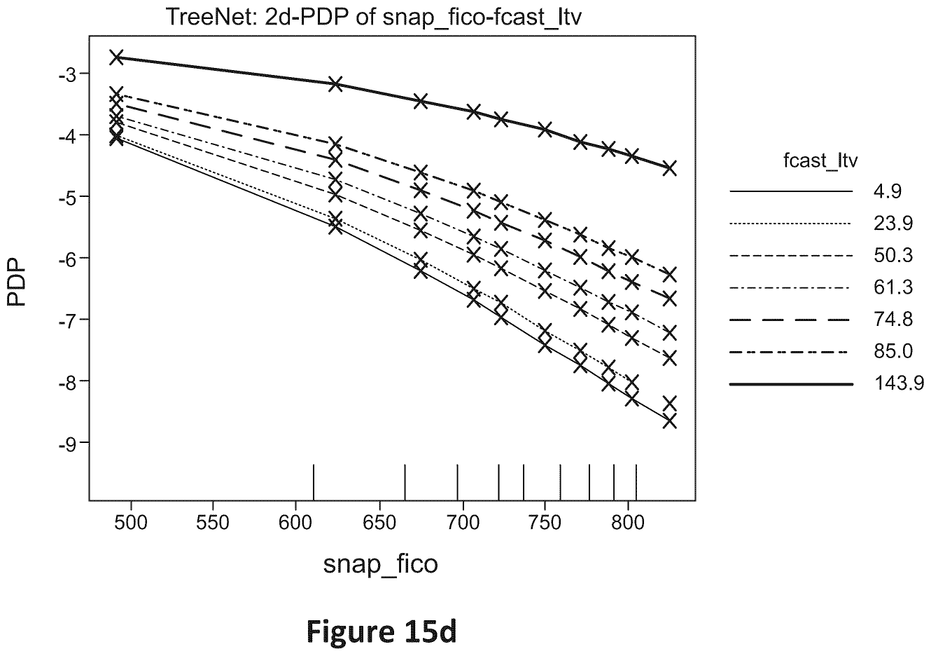

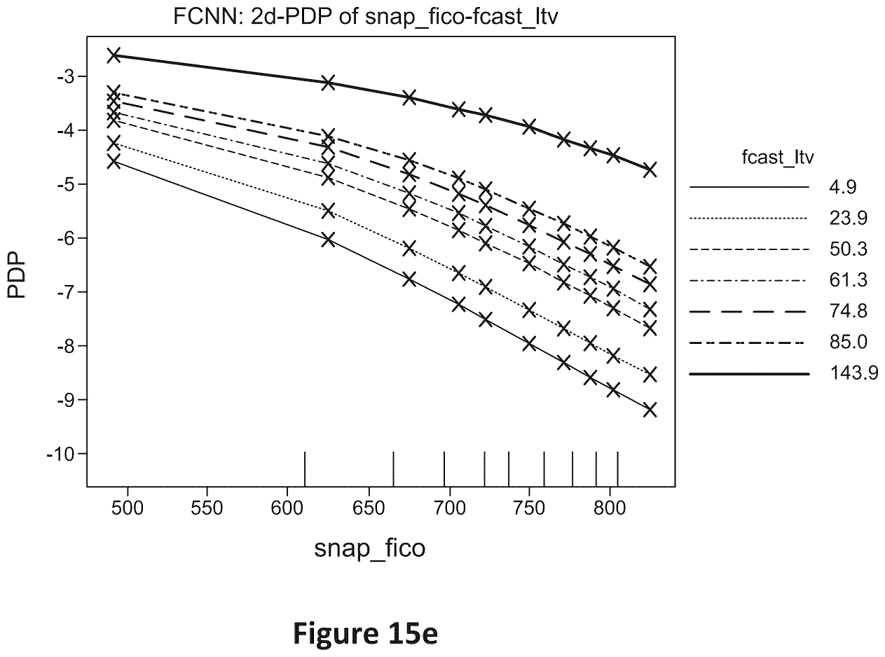

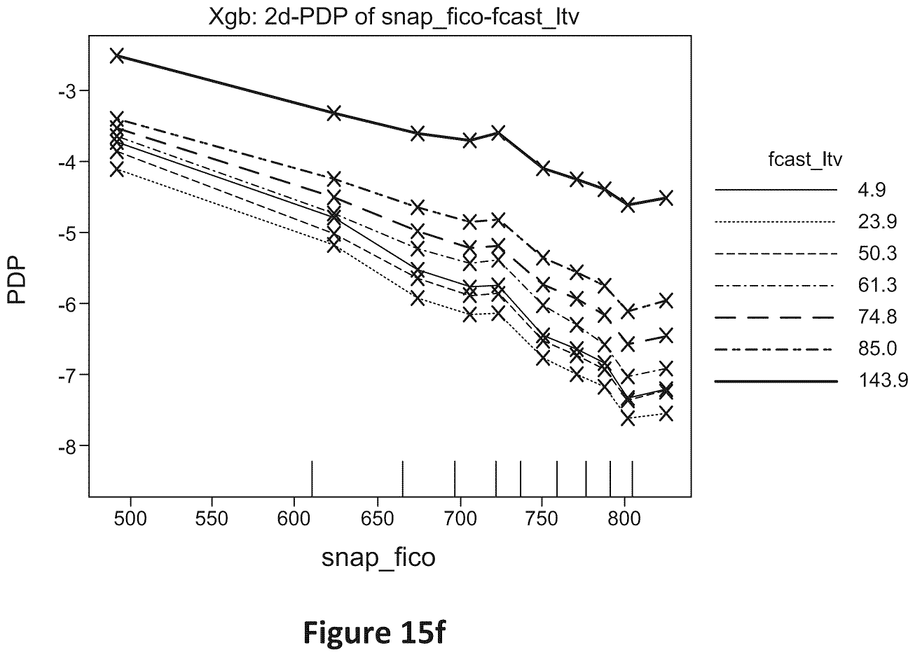

Two-way interaction effects were also examined. FIGS. 15a-15f illustrate the 2D partial dependence plots (PDPs) for the top two interaction effects with the largest H-statistics. The observed patterns are largely consistent across models. For example, the effect of the horizon variable changes direction depending on the early delinquency status, while the effect of the FICO score consistently shows a decreasing trend. However, the sensitivity of FICO to loan-to-value ratio diminishes as the loan-to-value ratio increases.

Some differences between the models were also observed. XGBoost, for instance, exhibits more pronounced kinks in the PDPs, similar to what is observed in the 1D PDPs. In contrast, FCNN demonstrates a stronger linearity effect, which can be attributed to its use of the ReLU activation function.

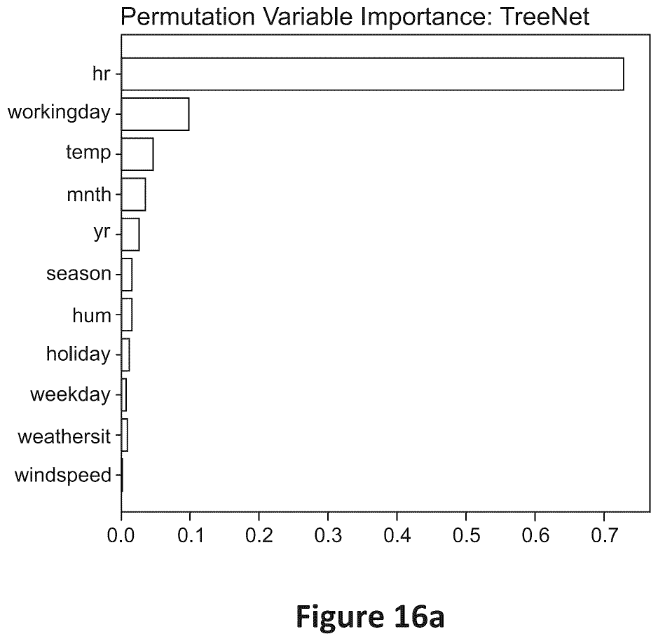

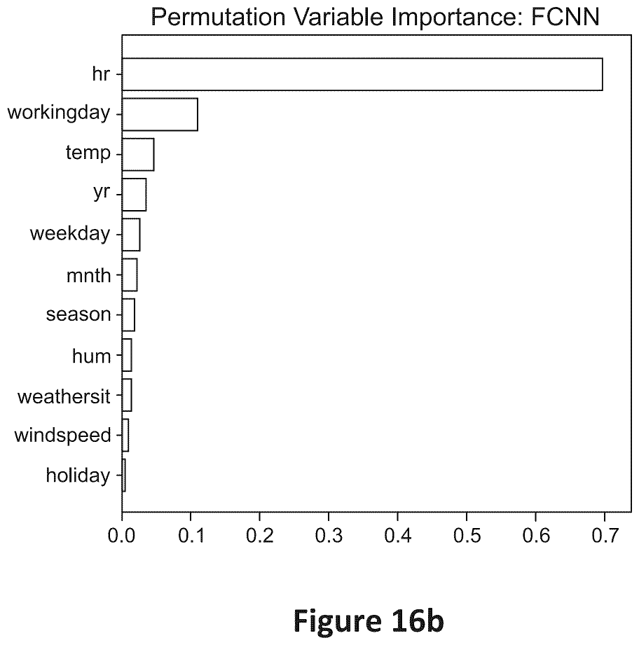

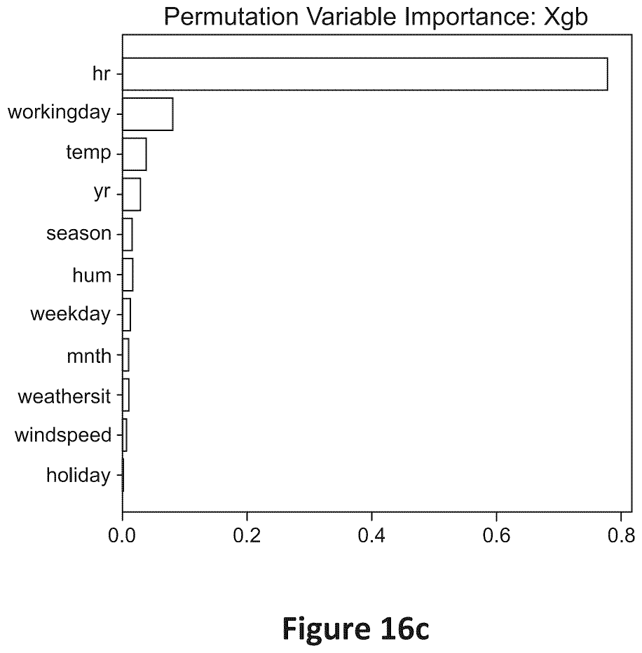

For the bike-sharing dataset, the variable importance scores for TreeNet, XGBoost, and FCNN are presented in FIGS. 16a-16c. The top three most important variables are consistent across all three algorithms. Notably, the variable “hour” stands out as the most significant, accounting for the majority of the importance scores.

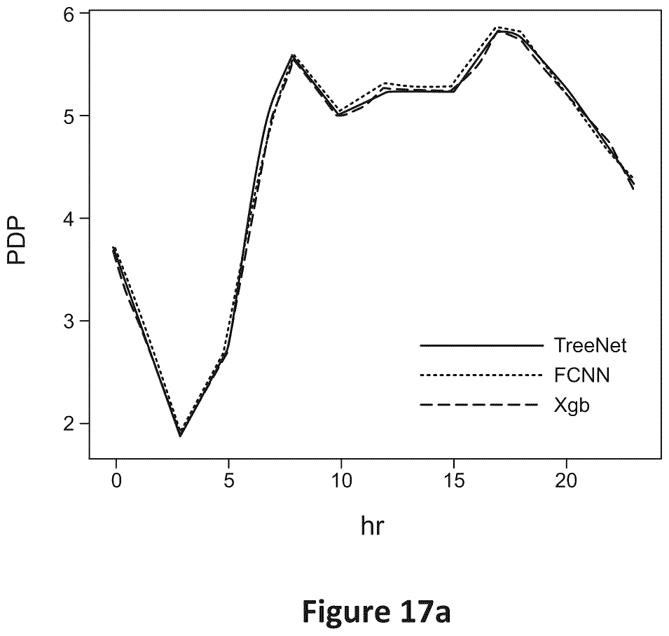

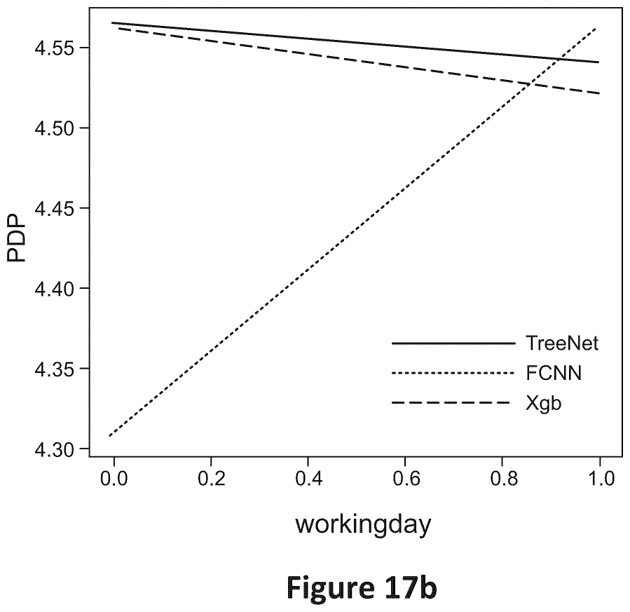

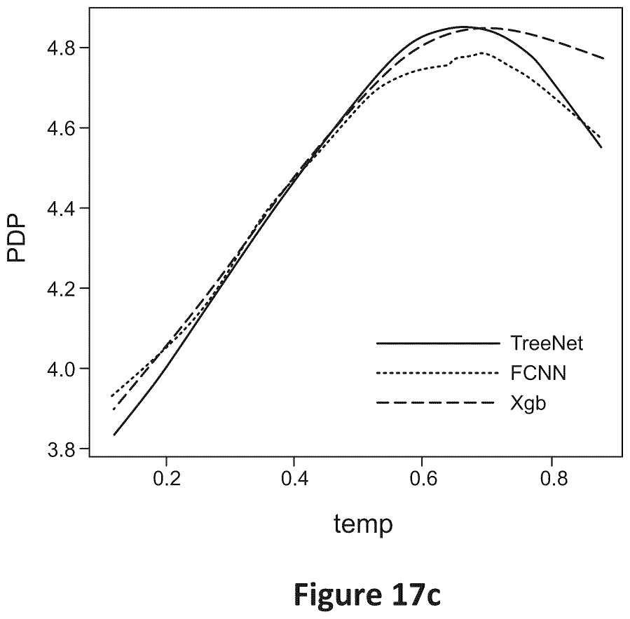

The 1D partial dependence plots (PDPs) for the top three variables are displayed in FIGS. 17a-17c. For the variable “hour,” the patterns are nearly identical across all three algorithms. For the other two variables, TreeNet shows a closer alignment with XGBoost, while FCNN exhibits some deviations. These differences may stem from TreeNet and XGBoost having more similar model performance, both of which slightly outperform FCNN.

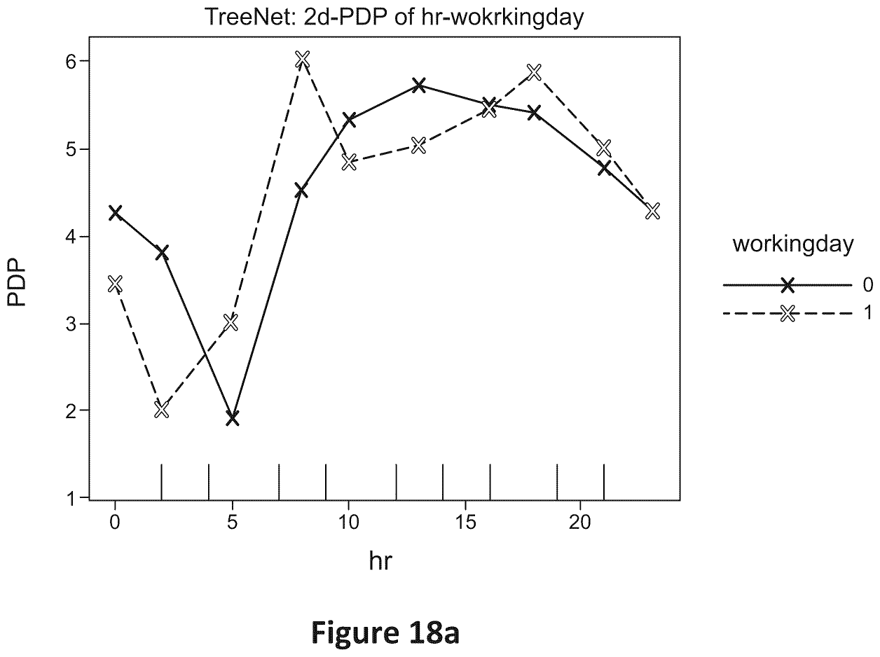

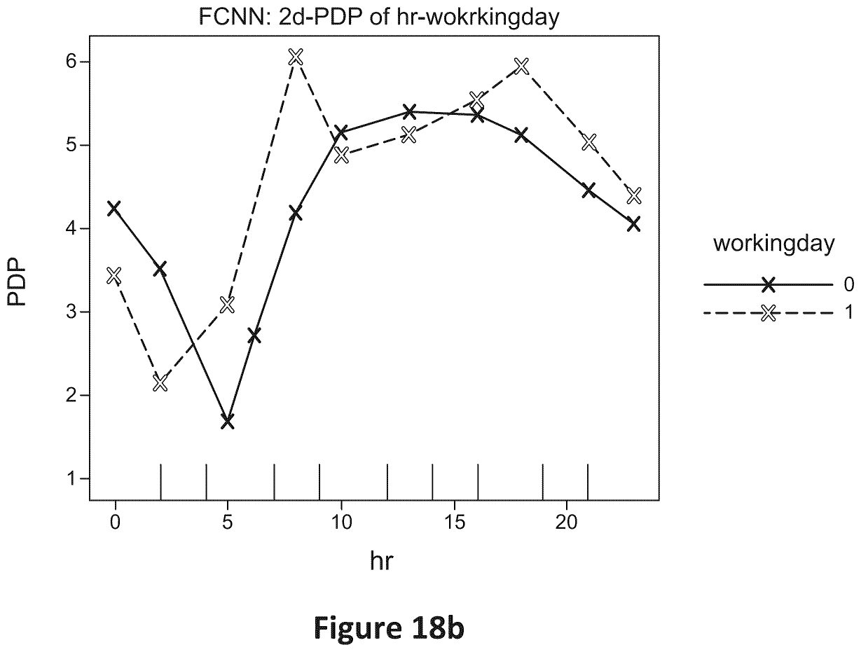

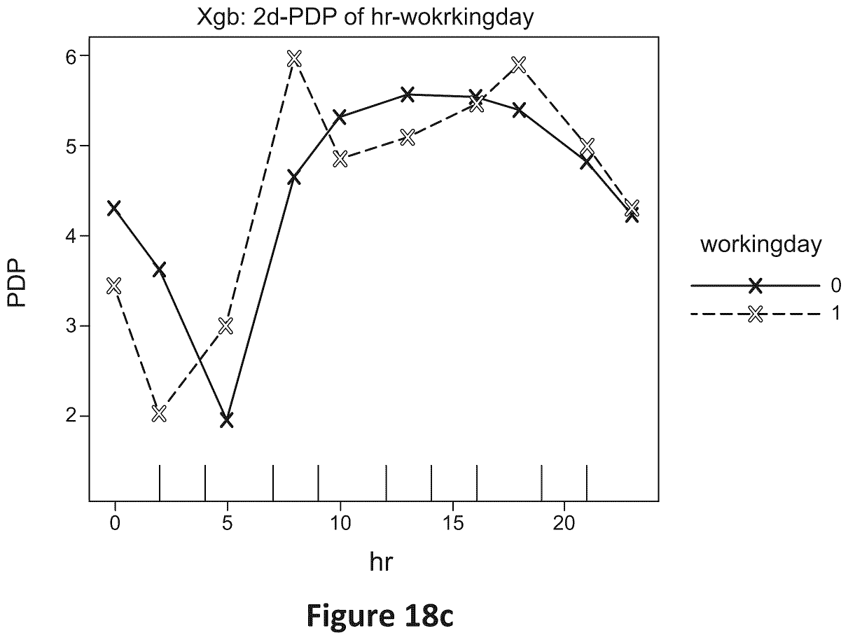

Two-way interaction effects were also examined, with “hour” and “working day” identified as having the largest interaction effect, as measured by H-statistics. This interaction is substantially stronger than any others. FIGS. 18a-18c present the 2D PDPs for this interaction, which show a consistent pattern across the models. On non-working days, bike rentals peak around noon, whereas on working days, rentals peak during the morning and afternoon rush hours, reflecting typical commuting patterns.

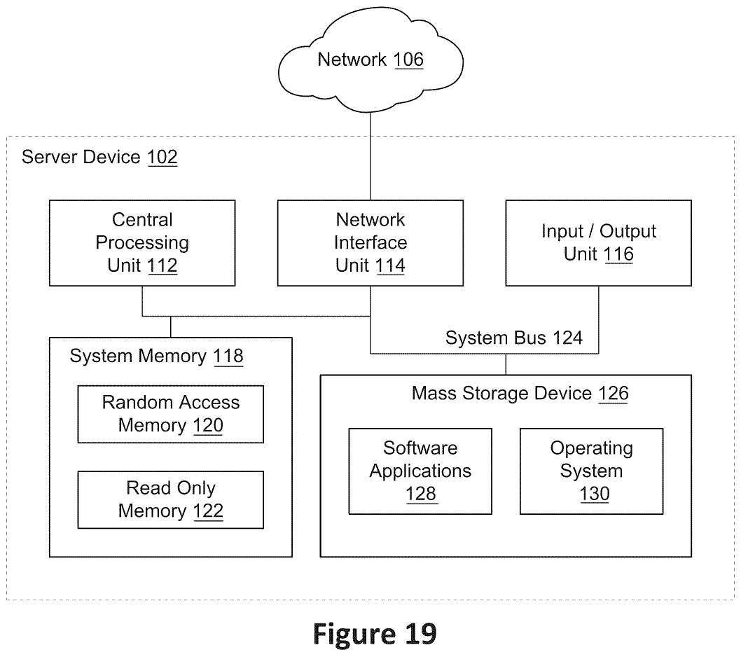

As illustrated in the embodiment of FIG. 19, the example server device 102, which provides the functionality described herein, can include at least one central processing unit (CPU) 112, a system memory 118, and a system bus 124 that couples the system memory 118 to the CPU 112. The system memory 118 includes a random access memory (RAM) 120 and a read-only memory (ROM) 122. A basic input/output system containing the basic routines that help transfer information between elements within the server device 102, such as during startup, is stored in the ROM 122. The server device 102 further includes a mass storage device 126. The mass storage device 126 can store software instructions and data. A central processing unit, system memory, and mass storage device similar to that shown can also be included in the other computing devices disclosed herein.

The mass storage device 126 is connected to the CPU 112 through a mass storage controller (not shown) connected to the system bus 124. The mass storage device 126 and its associated computer-readable data storage media provide non-volatile, non-transitory storage for the server device 102. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (DVDs), other optical storage media, magnetic cassettes, magnetic tape, magnetic disk storage or other magnetic storage devices, or any other medium which can be used to store the desired information and which can be accessed by the server device 102.

According to various embodiments of the invention, the server device 102 may operate in a networked environment using logical connections to remote network devices through network 106, such as a wireless network, the Internet, or another type of network. The network 106 provides a wired and/or wireless connection. In some examples, the network 106 can be a local area network, a wide area network, the Internet, or a mixture thereof. Many different communication protocols can be used.

The server device 102 may connect to network 106 through a network interface unit 114 connected to the system bus 124. It should be appreciated that the network interface unit 114 may also be utilized to connect to other types of networks and remote computing systems. The server device 102 also includes an input/output controller 116 for receiving and processing input from a number of other devices, including a touch user interface display screen or another type of input device. Similarly, the input/output controller 116 may provide output to a touch user interface display screen or other output devices.

As mentioned briefly above, the mass storage device 126 and the RAM 120 of the server device 102 can store software instructions and data. The software instructions include an operating system 130 suitable for controlling the operation of the server device 102. The mass storage device 126 and/or the RAM 120 also store software instructions and applications 128, that when executed by the CPU 112, cause the server device 102 to provide the functionality of the server device 102 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer system for machine learning-based prediction, comprising:
one or more processors; and
non-transitory computer-readable storage media encoding instructions which, when executed by the one or more processors, cause the computer system to:
apply a neural network-based spline transformation to input variables to generate transformed features;
process the transformed features using a cross network, wherein the cross network comprises one or more cross layers, wherein the one or more cross layers are configured to model feature interactions by combining input feature values with learned weight parameters and apply an additive transformation that incorporates a prior layer output; and
generate an output prediction based on the transformed features processed by the cross network.

2. The computer system of claim 1, wherein the neural network-based spline transformation includes at least one of: spline transformation, sigmoid transformation, indicator function transformation, and the above transformation on linear projection of the input feature values.

3. The computer system of claim 1, wherein the neural network-based spline transformation is configured to generate the transformed features in a form of a polynomial function applied to a spline transformation of the input variables.

4. The computer system of claim 1, wherein the neural network-based spline transformation is configured to approximate non-linear relationships using a sigmoid basis function of a form: σ(α+βx), where β and α are tunable parameters.

5. The computer system of claim 1, wherein a dimension reduction operation is applied to the transformed features after the neural network-based spline transformation.

6. The computer system of claim 1, wherein the cross network is configured to limit a highest order of feature interactions to a predetermined depth, thereby controlling model complexity and reducing overfitting.

7. The computer system of claim 1, wherein the cross network is configured to generate polynomial interaction terms up to a predefined degree by stacking multiple cross layers, thereby modeling complex relationships between features.

8. The computer system of claim 1, wherein the cross network comprises a configurable number of cross layers, wherein a number of cross layers is a hyperparameter that can be tuned based on a validation dataset.

9. The computer system of claim 1, wherein the one or more cross layers in the cross network are configured to iteratively refine feature interactions by applying multiple stages of feature transformation, wherein each stage incorporates prior layer outputs to construct higher-order feature interactions.

10. The computer system of claim 1, wherein the input variables processed by the neural network-based spline transformation are derived from structured data or tabular data.

11. A method for machine learning-based prediction, comprising:
applying a neural network-based spline transformation to input variables to generate transformed features;
processing the transformed features using a cross network, wherein the cross network comprises one or more cross layers, each cross layer being configured to model feature interactions by combining input feature values with learned weight parameters and applying an additive transformation incorporating a prior layer output; and
generating an output prediction based on the transformed features processed by the cross network.

12. The method of claim 11, wherein the neural network-based spline transformation includes at least one of: spline transformation, sigmoid transformation, indicator function transformation, and the above transformation on linear projection of the input feature values.

13. The method of claim 11, wherein the neural network-based spline transformation generates the transformed features in a form of a polynomial function applied to a spline transformation of the input variables.

14. The method of claim 11, wherein the neural network-based spline transformation approximates non-linear relationships using a sigmoid basis function of a form: σ(α+βx), where β and α are tunable parameters.

15. The method of claim 11, further comprising applying a dimension reduction operation to the transformed features after the neural network-based spline transformation.

16. The method of claim 11, wherein the cross network limits a highest order of feature interactions to a predetermined depth, thereby controlling model complexity and reducing overfitting.

17. The method of claim 11, wherein the cross network generates polynomial interaction terms up to a predefined degree by stacking multiple cross layers, thereby modeling complex relationships between features.

18. The method of claim 11, wherein the cross network comprises a configurable number of cross layers, wherein a number of cross layers is a hyperparameter that is tuned based on a validation dataset.

19. The method of claim 11, wherein the one or more cross layers in the cross network iteratively refine feature interactions by applying multiple stages of feature transformation, wherein each stage incorporates prior layer outputs to construct higher-order feature interactions.

20. The method of claim 11, wherein the input variables processed by the neural network-based spline transformation are derived from structured or tabular data.
